(19) United States
(12) Patent Application Publication
(10) Pub. No.: US 2020/0387627 A1
(43) Pub. Date: Dec. 10, 2020

(54) MULTI-USER DATABASE SYSTEM AND METHOD

(71) Applicant: Digital Asset Holdings, LLC, New York, NY (US)

(72) Inventors: Shaul KFIR, New York, NY (US); Simon MEIER, Zurich (CH); James Benton LITSIOS, Zurich (CH)

(73) Assignee: Digital Asset Holdings, LLC

(21) Appl. No.: 16/516,910

(22) Filed: Jul. 19, 2019

Related U.S. Application Data
(60) Provisional application No. 62/856,808, filed on Jun. 4, 2019.

(51) Int. Cl. G06F 21/62; G06F 21/60; G06F 16/23; G06F 9/46; G06F 21/31

(52) U.S. Cl. CPC G06F 21/6245; G06F 21/602; G06F 21/31; G06F 9/466; G06F 16/2308

(57) ABSTRACT

A database system (1) and method (100) comprising a database system memory (3) and at least a first database server (9). The database system memory (3) stores a database of data records (7) and shared program instructions (51) between first and second database users (21, 31). The shared program instructions (51) define a privacy model (13) comprising privacy restrictions (14, 23, 33) for the first and second database users (21, 31), respectively, and specify an authorization model (19) comprising a first set of authorizations (25′, 35′) that permit the first database user (21) to manipulate a first subset (27) of the data records consistent with the first user's privacy restrictions (23′, 33′) and a second set of authorizations (25″, 35″) that permit the second user (31) to manipulate a second subset (37) of the data records consistent with the second user's privacy restrictions (23″, 33″). The database server (9) includes a processor (11) configured to execute the shared program instructions (51), wherein the shared program instructions (51), when executed by the processor (11): (1) process (110) a transaction (53) submitted by the first or second database user (21, 31); (2) determine (120) whether the transaction (53) conforms to the privacy and authorization models (13, 19); and (3) if the transaction passes step 2, commit (130) the transaction (53) and manipulate (55) the first or second subset of data records (27, 37) consistent with privacy and authorization models (13, 19).

### TECHNICAL FIELD

The present disclosure relates to a database system and a method of processing transactions using a database system shared with multiple users.

### BACKGROUND

Business processes, for example multi-party business processes, can be hard to implement within databases (e.g., SQL and NoSQL), especially when the multi-party process involves private business processes of database users. Database systems historically are ill-suited to maintaining privacy in a multi-party process. While state machines can be used to implement business models within database systems, state machines and database system access control fail to: (i) naturally capture the authorizations needed to permit evolution of multi-party business processes under specific constraints, (ii) model privacy constraints, (iii) ensure database system access control authorizations can evidence the accountability of database system users to delegate parts of a multi-party business process to other database system users, and (iv) ensure database system users can coordinate their authorizations to execute specific business processes when requested (e.g., by other database system users).

Distributed ledger technology (hereinafter, “DLT”) and blockchain have attempted to facilitate multi-party business processes by implementing a distributed ledger that records multi-party business processes in the form of smart contracts (program code recorded on a ledger). Yet, existing DLT and blockchain solutions can suffer from several downsides, including for example that blockchains typically require: (i) a consensus mechanism/algorithm for distributed nodes to arrive at consensus on the correct “state” of the blockchain (and thus smart contracts recorded to the blockchain), and (ii) a replication mechanism to propagate state changes to all nodes in a distributed system. Both (i) and (ii) ensure that nodes in the distributed system are in sync as to the state of the ledger, including their shared business processes. Yet, (i) and (ii) in addition to other operations generally performed in blockchain or DLT implementations result in high overhead to the distributed system, as well as make the distributed system difficult to scale. For instance, if a blockchain or DLT is running a consensus mechanism/algorithm, it can be difficult to vertically scale throughput (transactions/sec) of the network. Similarly, utilizing a replication mechanism can introduce latency into the system.

The present disclosure solves a number of existing issues by providing a shared database system and privacy-preserving programming semantic between different parties to facilitate multi-party execution of programs with privacy and at scale.

### SUMMARY

A first aspect of the disclosure includes a database system comprising a database system memory and at least a first database server. The database system memory stores a database of data records and shared program instructions between first and second database users, wherein the shared program instructions define a privacy model comprising privacy restrictions for the first and second database users, respectively, and specify an authorization model comprising a first set of authorizations that permit the first database user to manipulate a first subset of the data records consistent with the first user's privacy restrictions and a second set of authorizations that permit the second user to manipulate a second subset of the data records consistent with the second user's privacy restrictions. The database server includes a processor configured to execute the shared program instructions, wherein the shared program instructions, when executed by the processor:
1) process a transaction submitted by the first or second database user;
2) determine whether the transaction conforms to the privacy and authorization models; and
3) if the transaction passes step 2, commit the transaction and manipulate the first or second subset of data records consistent with privacy and authorization models.

In some examples, the database system further comprises program instructions stored with the memory that, when executed, validate that the transaction includes a cryptographic authorization from the first or second user consistent with the authorization model.

In some examples, the cryptographic authorization comprises the transaction being cryptographically signed by the first or second database user.

In some examples, the database system further comprises an evidence log and program instructions stored in the memory that, when executed by the processor, record an execution history of the shared program instructions, record a request to submit the transaction, and/or record any cryptographic authorizations submitted along with the transaction.

In a further example, the database system further comprises an execution engine including program instructions that, when executed by the processor, validate that the privacy restrictions for the first or second database user and the first or second set of authorizations conform to respective global rules for the database system, and record evidence of validation of the privacy restrictions and authorizations in the evidence log.

In some examples, the database system further comprises a transaction and concurrency engine having program instructions that, when executed by the processor, use a concurrency control protocol to process concurrent transactions submitted to the database system.

In some examples the shared program instructions are, at least in part, stored procedures stored in the memory, and the system further comprises a procedural handler configured to determine, from the transaction submitted by the first or second database user, one or more stored procedures suitable to process the transaction and process, at least in part, the transaction by executing the one or more stored procedures.

In some examples, the database system further comprises an execution engine configured to execute the shared program instructions and enforce the privacy and authorization models.

In a further example, the execution engine is configured to limit access to the data records in a manner consistent with the privacy model.

In an alternative example, the execution engine is configured to execute the shared program instructions and, if specified by the shared program instructions, alter the privacy and authorization models consistent with the shared program instructions.

In some examples, the transaction is submitted by the second database user and the shared program instructions, when executed by the processor, change at least the first database user's access to the first subset of the data records.

In another example, the transaction is submitted by the second database user and the shared program instructions, when executed by the processor, change at least the first database user's first set of authorizations that permit the first database user to manipulate the first subset of the data records.

In some examples, the shared program instructions, when executed by the processor, alter the privacy and authorization models only if certain data is present or not present in the evidence log or the transaction.

In some examples, the shared program instructions, when executed by the processor, perform step (3) and commit the transaction only if certain data is present or not present in the evidence log or the transaction itself.

In some examples, the shared program instructions, when executed by the processor, commit both the transaction and evidence of its privacy and authorization validity simultaneously.

A method of processing a plurality of transactions using a database system comprising a database system memory configured to store a database of data records, and at least a first database server including a processor, the method comprising:
A. processing a transaction submitted by a first or second database user to the database server;
B. determining whether the transaction conforms to a privacy model and an authorization model defined by shared program instructions between the first and second database users, wherein the privacy model comprises privacy restrictions for the first and second database users, respectively, and the authorization model comprises a first set of authorizations that permit the first database user to manipulate a first subset of the data records consistent with the first user's privacy restrictions and a second set of authorizations that permit the second user to manipulate a second subset of the data records consistent with the second user's privacy restrictions; and
C. if the transaction passes step (B), committing the transaction and manipulating the first or second subset of data records consistent with the privacy and authorization models.

In some examples, the method further comprises the step of validating that the transaction includes cryptographic authorization from the first or second database user in accordance with the privacy model and/or authorization model.

In some examples of the method, the transaction includes a request to manipulate, consistent with the first set of authorizations, the first subset of data records in response to a condition, wherein step (B) comprises verifying occurrence of the condition and manipulating the first subset of data records consistent with the privacy and authorization models.

In some examples of the method, the condition includes determining whether a status of another transaction or a subset of the data records meets certain criteria.

In some examples of the method, the privacy model and/or authorization model specify one or more anticipated actions or results, as part of the submitted transaction.

In some examples of the method, the database system further comprises an evidence log, the method further comprising:
A. recording an execution history of the first shared program instructions;
B. recording a request to submit the transaction, and/or
C. recording any cryptographic authorizations submitted along with the transaction.

In one example, the method further comprises validating that the privacy restrictions for the first or second database users in the privacy model and the first or second set of authorizations in the authorization model conform to respective global rules for the database system and recording evidence of validation of the privacy restrictions and authorizations in the evidence log.

In one example, the method further comprises executing a concurrency control protocol to process concurrent transactions submitted to the database system.

In some examples, the database system memory stores program instructions, at least in part, as stored procedures, wherein the method further comprises a procedural handler of the database server performing the steps of determining, from the transaction submitted by the first or second database user, one or more stored procedures suitable to process the transaction and processing, at least in part, the transaction by executing the one or more stored procedures.

### BRIEF DESCRIPTION OF DRAWINGS

Examples of the present disclosure are described with reference to the figures below:

FIG. 1 is a schematic diagram of an exemplary database system;

FIG. 2 is a diagram of exemplary privacy and authorization models and their use in the manipulation or reading of data records in the database system of FIG. 1;

FIG. 3 is a schematic diagram of shared code segments stored in the database system of FIG. 1;

FIG. 4 is an exemplary flow diagram of a computer-implemented method for processing a plurality of transactions using the database system of FIG. 1;

FIG. 5 is an example of a transaction submitted to the database server of FIG. 1;

FIG. 6 is a representative example of privacy and authorization restrictions;

FIG. 7 illustrates an example of a relational data record and respective code defining privacy restrictions;

FIG. 8 is an example of a set of authorizations that permit manipulation of a subset of data records;

FIG. 9 illustrates a schematic example of a native implementation of the database system of FIG. 1;

FIG. 10 illustrates an exemplary evidence and audit log of the database system of FIG. 1;

FIG. 11 illustrates a schematic example of a stored procedures implementation of the database system of FIG. 1;

FIGS. 12 to 17 illustrate example outputs of a transaction submitted to the database server of FIG. 1;

FIG. 18 is a schematic example of a processor.

### DESCRIPTION OF EMBODIMENTS

The present disclosure relates to a database system including a privacy and authorization-preserving programming semantic that facilitates multi-party processes between different users or entities. In an example, the database can utilize a relational (e.g., SQL), non-relational (e.g., NoSQL), graph, or another type of database model. In some examples the database can provide a centralized view of data that is accessible by multiple users (i.e., where the data is not replicated across nodes associated with each user of the database). In other words, in some examples the database can be a centralized database that does not use a distributed consensus protocol or a replication mechanism, and therefore is not a DLT. Thus, as described below, the database can provide multi-party execution of programs with privacy and proper authorization, without suffering from some of the existing deficiencies of DLT. Access to data on the database can be provided by way of a database management system that allows users and applications to interact with the database and data contained therein.

The common programming semantic of the database, referred to herein as DAML, allows database system users to express multi-party business logic and uses a specific runtime that ensures all database transactions are properly authorized by the correct party or parties, and that proper privacy constraints are enforced for data relating to transactions. DAML is described in detail in WO 2017/187394 (“DAML 2”) and WO 2019/082142 (“DAML 3”), the disclosures of which are hereby incorporated by reference herein in their entireties. The database system can store programs (e.g., expressed in DAML) that multiple parties can interact with and, when executed, can manipulate or read data records, evolve database schema, record evidence of execution of the stored programs, and other tasks with privacy and proper authorization. The result is a novel database system that, among multiple parties, is itself natively private, auditable, and preserves authorizations according to the common programming semantic (e.g., DAML).

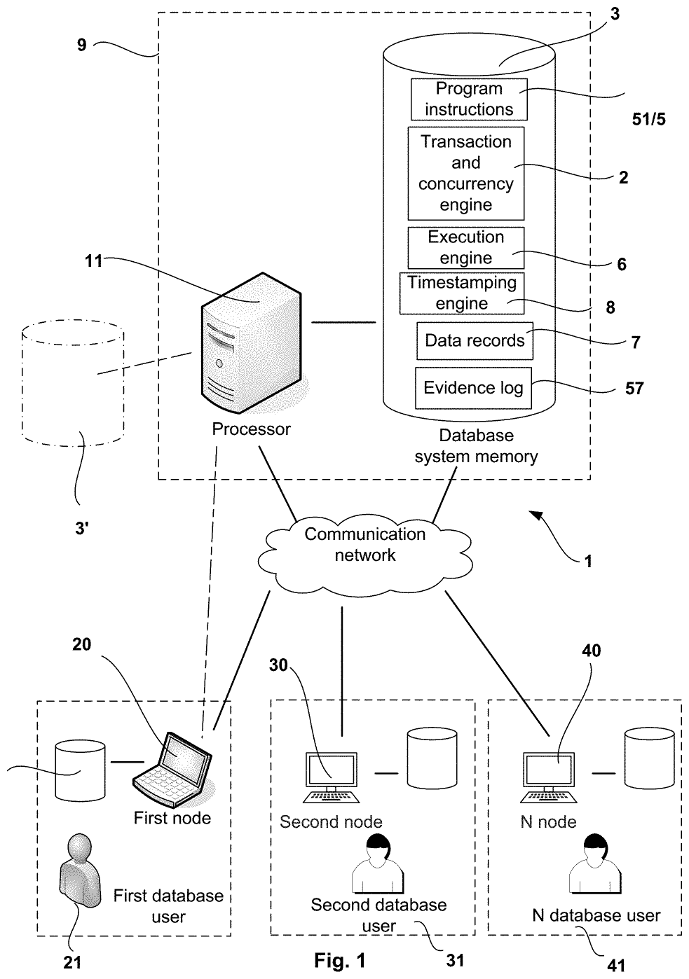

FIG. 1 illustrates an example of a database system 1 as described above. Below is a description of several of the components of the database system, followed by how database system 1 can be utilized along with a programming semantic (e.g., DAML) to facilitate execution of multi-party processes with privacy and proper authorizations.

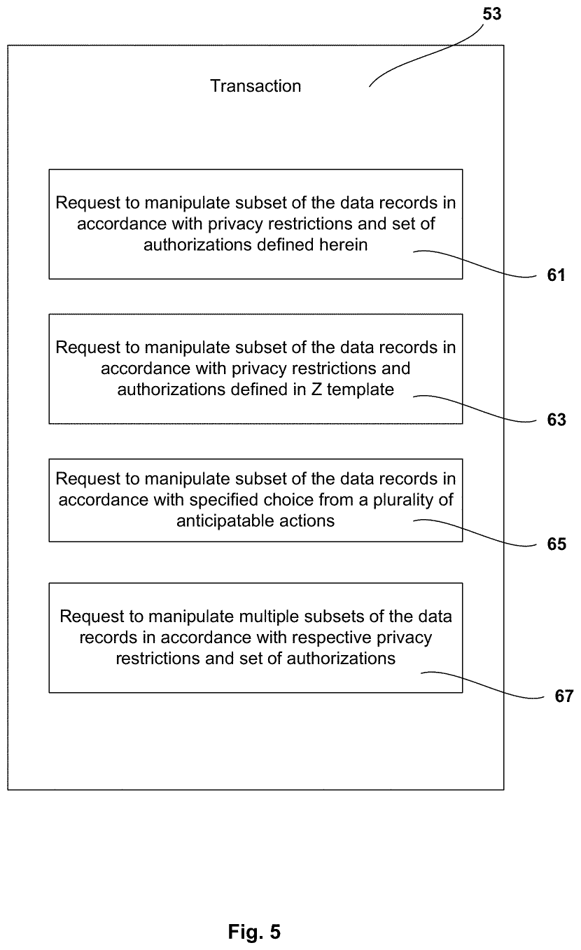

Database system 1 can include a database server 9 having a processor 11 and storage or memory 3. In an example, memory 3 can store program instructions 51 relating to programs expressed in the programming semantic (e.g., DAML), a database of data records 7, and/or an evidence log 57 recording details around the execution of program instructions 51 (e.g., upon transactions being submitted to database server 9). In an alternate example, program instructions 51 can be stored in storage or memory 3′ that does not form part of database server 9 (e.g., storage or memory located apart from database server 9). Program instructions 51 (e.g., DAML) can be executed by a database user 21, 31, 41 by submitting transactions 53 (FIG. 5) to database system 1. Transactions 53 can, in some cases, have the effect of manipulating data records 7, evolving database schema, or performing other database actions. In an example, details surrounding the execution of such program instructions 51 and/or each associated transaction 53 can also be recorded to evidence log 57 (e.g., for purposes of auditing the execution of program instructions 51 to confirm that the database contains an accurate state of data records 7). In this way, the details around the execution of program instructions 51, and therefore details of each transaction 53 can be evidenceable (i.e., able to be retrieved, verified and/or demonstrated to be authorized by a user via the evidence log 57). The process of executing program instructions 51 by submitting transactions 53 is described in more detail below in connection with the exemplary method of using database system 1.

### Persistence Module

Database system 1 can have a persistence module that persists programming instructions 51, for example programs expressed in DAML. In an example, the persistence module can be memory 3 that is part of database server 9, or alternatively memory 3′ located apart from database server 9. The persistence module can be used to persist programming instructions 51 so that, as described in more detail below, multiple database users 21, 31, 41 can submit transactions 53 to database system 1, for instance database server 9, and execute particular programs 51 that the specific user 21, 31, 41 is entitled to execute. Whether a database user 21, 31, 41 can execute a particular program 51, or part thereof, stored in the persistence module, and how or whether the executing database user 21, 31, 41 gets access to information and/or results from the execution of that program 51, can be determined by, inter alia: (i) how parties choose to express the program in DAML, and (ii) how DAML's authorization and privacy constraints are enforced by way of an execution engine 2 (described more fully below) used to execute the DAML program.

### Transaction and Concurrency Engine

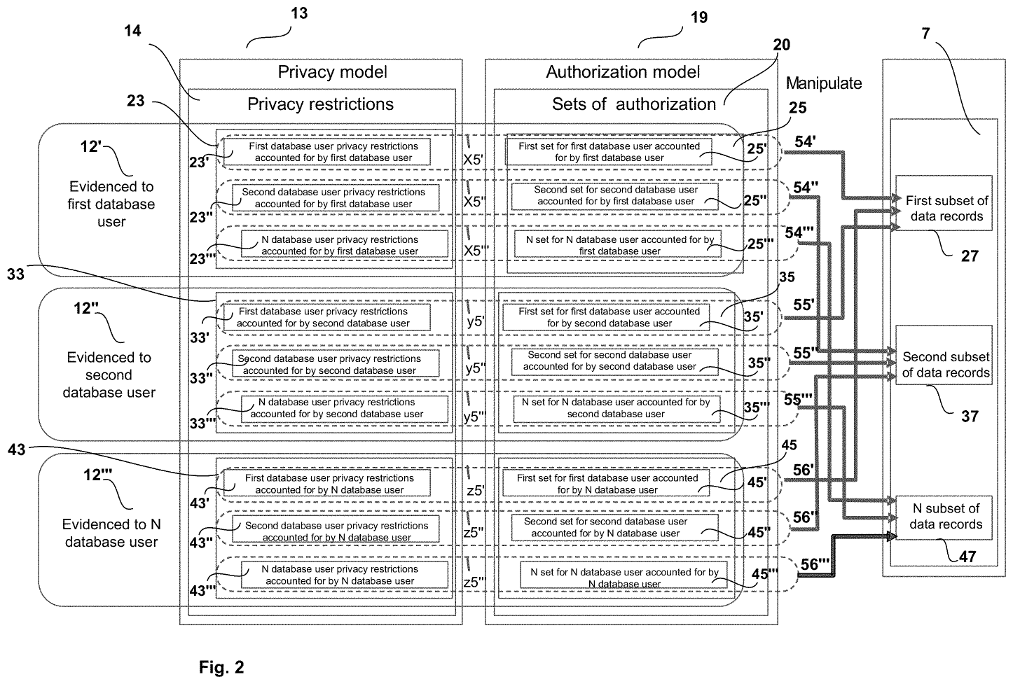

Database system 1 can have a transaction and concurrency engine 6 that can process transactions 53 submitted to database system 1. Transactions 53 can be the primary mechanism by which database users 21, 31, 41 access and/or manipulate data records 7 stored in the persistence module (e.g., memory 3). Transaction and concurrency engine 6 can function to receive submitted transactions 53 concurrently from multiple database users 21, 31, 41, process such transactions 53 and, if conforming to privacy 13 and authorization models 19 (FIG. 2) of programming instructions 51, commit and affect the requested manipulation 54′, 54″, 54′″, 55′, 55″, 55′″, 56′, 56″, 56′″ of or access to data records 7. Frequently, a transaction 53 can be a request to execute a particular program(s) 51, or part thereof, stored in the persistence module. As described in more detail below, transaction and concurrency engine 6 and execution engine 2 can therefore be used to determine which transactions 53 submitted to database system 1 are valid and can be committed. If committed, a transaction 53 can result in execution of a DAML program(s) 51, or part thereof, on behalf of one or more database users 21, 31, 41, thereby allowing multi-party definition and execution of programs 51 using database system 1.

Transaction and concurrency engine 6, in an example, only processes transactions 53 submitted by any of database users 21, 31, 41 that are permitted according to the shared programming semantic (DAML) that exists between users 21, 31, 41. Stated differently, in an embodiment of the DAML context, a transaction 53 requesting execution of a DAML program(s) 51 must be permitted according to the authorization and privacy constraints of the DAML program(s) 51 that specific database users authorize and commit to database system 1 (e.g., store in the persistence module for later execution by such database users).

In some embodiments, the authorization and privacy constraints of the DAML program(s) 51 and data can depend both on the dynamic context of execution of the DAML program(s) 51 and the dynamic context of data creation of the accessed data (such as data records 7) of the database system 1. This means that the authorization constraints of a user can change as a DAML program 51 is executed by the system 1 and changes state. In this way, the system 1 enables separate, programmatically-defined access control to be combined into anticipatable, scalable and safe systems of access control.

The mechanism for database users to specify the types of DAML programs that can be executed, and which parts, is described below in a more detailed discussion of DAML as it applies to database system 1. In an example, a transaction 53, if valid and committed to database system 1 after processing by transaction and concurrency engine 6, can execute DAML program instructions 51 that:
1. Write or read data to a portion of data records 7 that database users 21, 31, 41 are permitted to access (e.g., as specified by the privacy 13 and authorization models 19 of DAML enforced upon execution).
2. Manage or evolve database schema (e.g., add, modify, or delete tables in a relational database, add, modify, or delete row and/or column structure in a relational database, etc.).
3. Manage authorizations and access control to database system 1 by any of the database users 21, 31, 41 to:
   a. Read and write to certain data records 7 in the database.
   b. Execute specific parts of DAML programs (e.g., a shared code segment 5).
   c. Delegate execution authorization and access control in relation to part of a DAML program (e.g., a shared code segment 5) to another database user 21, 31, 41.
   d. Coordinate later execution of DAML programs (e.g., shared code segments 5) under specified conditions.
   e. Coordinate later execution of DAML programs (e.g., shared code segments 5) under specific conditions and commit to preserve uniqueness and data invariant properties of queriability of the data associated to selected stored code.
   f. Coordinate evidencing (e.g., for traceability or accountability) of authorizations and access control made possible by authorized operations of user 21, 31, 41, while also authorizing later execution of DAML programs (e.g., shared code segments 5) under specific conditions by user 21, 31, 41.
   g. Migrate database schema.

As described in more detail below in connection with an exemplary method of using database system 1, the different functions of a transaction 53 can act to provide a multi-party database system 1 that allows execution of DAML programs 51, multi-party migration of database schema, and other database operations to allow any number of database users to use a single database system 1. As a result, any number of database users can access a multi-party database system 1 and utilize a joint ledger of their respective data, with privacy and proper authorization, and without some drawbacks of DLT systems like lower scalability or increased latency.

Database system 1, for instance its transaction and concurrency engine 6, can also utilize a concurrency protocol to permit concurrent transactions 53 while maintaining important transactional properties (e.g., atomicity, consistency, isolation, and durability). Atomicity—that either execution of all of a transaction occurs or no execution occurs—can be achieved along with transactional isolation by using any of the following concurrency mechanisms, alone or in combination, in database system 1:
1. Locking (e.g., two-phase locking) that controls access to data by locks assigned to the data. Access of a transaction to a data item (e.g., database record) locked by another transaction may be blocked (depending on lock type and access operation type) until lock release.
2. Serialization graph checking (also called serializability, or conflict, or precedence graph checking) that checks for cycles in the schedule's graph and breaking them by aborts.
3. Timestamp ordering (TO) that assigns timestamps to transactions, and controlling or checking access to data by timestamp order.
4. Commitment ordering (or commit ordering) that controls or checks a transactions' chronological order of commit events to be compatible with their respective precedence order.

In addition, it is to be appreciated that other concurrency control types may also be utilized alone, or in conjunction with the above, including:
5. Multiversion concurrency control (MVCC) to increase concurrency and performance by generating a new version of a database object (e.g., data record) each time the object is written, and allowing transactions' read operations of several last relevant versions (of each object) depending on scheduling method.
6. Index concurrency control, which permits synchronizing access operations to indexes, rather than to user data.
7. Private workspace model (deferred update model). Each transaction maintains a private workspace for its accessed data, and its changed data become visible outside the transaction only upon its commit
8. Conflict-free replicated data type (CRDT) model. Each replicated view can be updated independently and concurrently without coordination between the replicas, while possible resulting inconsistencies can always be resolved. In a DAML context, inconsistencies can be resolved within a pre-agreed process (exemplary defined with DAML).

As described above, transaction and concurrency engine 6 can therefore concurrently process transactions 53 submitted by different database users 21, 31, 41 so that such users can compose DAML programs 51 that define the multi-party database actions and rights provided to each user 21, 31, 41.

### Execution Engine

Database system 1 can further include an execution engine 2 for executing program instructions 51 (e.g., DAML programs). Execution engine 2 can include a runtime system with a runtime environment for the execution of DAML program instructions 51.

In an example, the runtime system of execution engine 2 can receive a submitted operation from user 21, 31, 41 to modify a shared database state through the authorized execution of program instructions 51 that creates, reads, updates, and/or deletes stored data. The operation can be part of a sequence of operations, such as transaction 53. In the DAML context of database system 1, authorization to modify and access data associated to shared multi-user programming semantics can depend on previously submitted operations or transactions 53. In further examples, authorization can also depend on the specific identity of the submitting users 21, 31, 41. These authorizations may also depend on specific users being given authorization through a DAML execution, such as access rights. In an example, the DAML execution engine 2 can perform the following steps:
1. Receive an operation (or transaction 53) initiated and submitted by one or more database users 21, 31, 41.
2. Compute the operation result matching the expected operation result. In an example, this can involve executing an executable DAML program (e.g., instructions 51) that is recorded to database system 1 using the runtime system of execution engine 2 to compute an expected operation result based, at least in part, on data that is received by the submission of an operation or transaction 53 by the database user 21, 31, 41.
3. Validate the correctness of the expected operation result and commit the expected operation result to database system 1 (e.g., by manipulating one or more data records 7) while ensuring data-change consistency and privacy and authorization constraints. In an example, this can involve checking that privacy model 13 and authorization model 19, as well as data-change consistency constraints, are respected as part of executing the executable DAML program 51 using the runtime system of execution engine 2, as mentioned in step 2.
4. Communicate the committed operation result to authorized users of system 1.
5. Receive communication of reception of the committed operation result by the authorized users of step 4.

In an example, step 3 above can rely on a log of previous operations or transactions. In another example, step 3 can rely on additional data being stored directly with the data received by the submission of the operation by the user.

As described above, prior to committing the expected operation result to database system 1, execution engine 2 can validate the correctness of the expected operation result. This can include checking privacy constraints, authorization constraints and data-change consistency constraints. As also described above, authorization and privacy constraints can depend on dynamic factors such as the dynamic context of execution of the DAML program 51. In this way, prior to commitment of the expected operation result (and thus transaction 53), database system 1 can enable the submitted operation/transaction to delete part or all of any newly created data. In an example, such deleted data that can be referred to as transient data since the data is in a transient state (e.g., it exists for the duration of a transaction 53 and then is deleted within that same transaction 53). Stated differently, database system 1 can provide for authorization and privacy constraints to depend on transient data and on the dynamic creation and deletion of transient data.

In an example, execution engine 2 can coordinate with transaction and concurrency engine 6 of system 1 and provide one or more transactional properties to the finalized results (i.e., the committed expected operation or transaction results). For example, as described above transactional properties may include atomicity, consistency, isolation, and durability.

In the DAML context, transactionality of system 1 is achieved natively with memory mapped files and the use of an ‘fsync’ like operating system command Transactionality can also be achieved with a database engine working locally with the DAML execution engine 2, an enterprise server or container services (e.g., Java application servers, Kubernetes' ReplicaSet and StatefulSet), and a remote database service. Similarly, reliable delivery and receipt reception can be achieved with a reliable message delivery between users 21, 31, 41 and the DAML execution engine 2.

In a further example, execution engine 2 can comprise instructions that, when executed as part of a transaction by a database user 21, 31, 41, validates that the authorized execution deriving from the finalized and committed transaction 53 satisfies privacy restrictions and authorization conditions. The privacy restrictions and authorization conditions can be captured in privacy model 13 and authorization model 19, respectively. An exemplary authorization condition can ensure that no database user's authorization is evidenced without the requested authorization of the database user 21, 31, 41. The requested authorization of the database user may be a cryptographic authorization.

In further examples, distributed execution of program instructions 51 over multiple DAML execution engine nodes 2 can be provided. For example, one or more distributed consensus protocols to transition steps 2 to 3, and steps 4 to 5 above can be used. Exemplary use of a distributed consensus protocol can be coordinated with the transaction and concurrency engine 6 of system 1.

Strong privacy of a business process can be achieved when steps 1 to 5 above are partitioned by DAML privacy and data sharing concerns within an exemplary DAML execution engine 2. In effect, steps 1 to 5 happen separately by users, or groups of users, that share the same privacy view of all or part of the DAML operations. In this way privacy can be achieved through:
Physical separation of the execution engine 2 computation flows by operation privacy view.
Physical separation of memory 3, 3′ of all or part of operations by privacy view.
Separate communication per user, or group of users, of operation results and receipt of operation results.
Use of data encryption accessible by user, or group of users.
Encrypted execution of operation within the DAML privacy and authorization rules with the use of Zero Knowledge Proofs (ZKP) or similar crypto-algebraic methods.
Use of dedicated secure hardware features (e.g., a trusted execution environment or secure enclave, such as Intel SGX) to attest the execution of the database system 1 relies only on authenticated version of the database system 1, and attest to the authenticity of the privacy model 13 implemented by the aforementioned execution.

In a further example, likewise to distributed execution of program instructions 51, an exemplary use of a privacy consensus protocol to transition steps 2 to 3, and steps 4 to 5 above can ensure that the DAML privacy and data sharing concerns is correct. A privacy consensus protocol can also ensure that the same result is seen in whole or in part by all affected and authorized users of the operations or transactions 53. In an example, use of a privacy consensus protocol can be coordinated with the transaction and concurrency engine 6 of system 1.

### Execution of DAML Program Instructions

In the context of the present system 1, execution of a DAML operation or transaction (via program instructions 51) can happen:
Over multiple steps (e.g., 1 to 5 above);
Over multiple execution entities (nodes, cores, machines); and
Over multiple privacy views (see e.g., privacy consensus as described above).

In addition, DAML programs can only progress and affect data within specific and well-defined rules (that is, the DAML semantics as described in further detail below). For this reason, validation can be a central part of the execution of a DAML operation within a DAML program. In addition, execution of a DAML program can have the DAML program being shared and communicated to the users and execution nodes, prior to the users submitting specific operations to execute shared segments of the shared program. This allows the DAML execution engine 2 to analyse and precompute program execution and data flow properties as an integral part of the execution process. This can also achieve the following purposes:
Validating that the program 51 meets the rules defined by the DAML semantics. For example, precompute that DAML operations do not put users into states they have not agreed to.
Enabling a broader execution platform and higher performance For example, by converting the program 51 from one form of executable code to another (e.g., to SQL, Java bytecode, or .NET CLI from DAML surface language to DAML core language).
Enabling a broader user application integration. For example, by converting the program from one form of source code to another to enable a wider scope. This may include converting and extracting language embedded DAML to native DAML (e.g., extract Java embedded DAML for the purpose of DAML execution within a Java enterprise server).
Optimizing operation execution and data transfer with precomputed execution and data properties. For example, to generate precompiled execution step, communication, and consensus protocols, as well as privacy groups (e.g., within steps 1 to 5 above).

### DAML

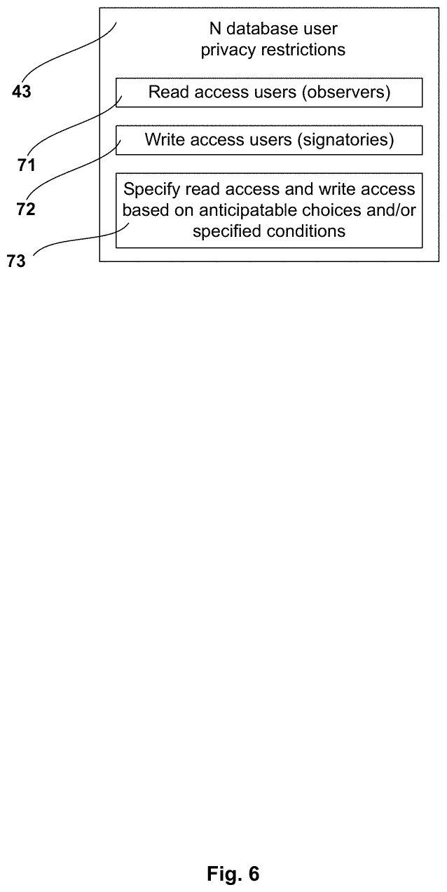

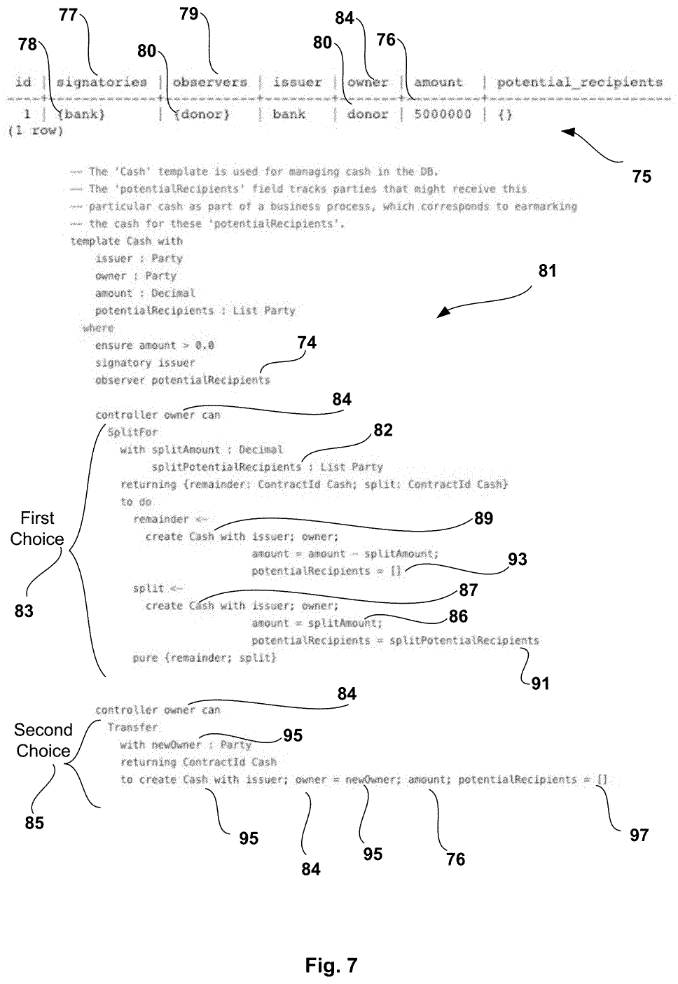

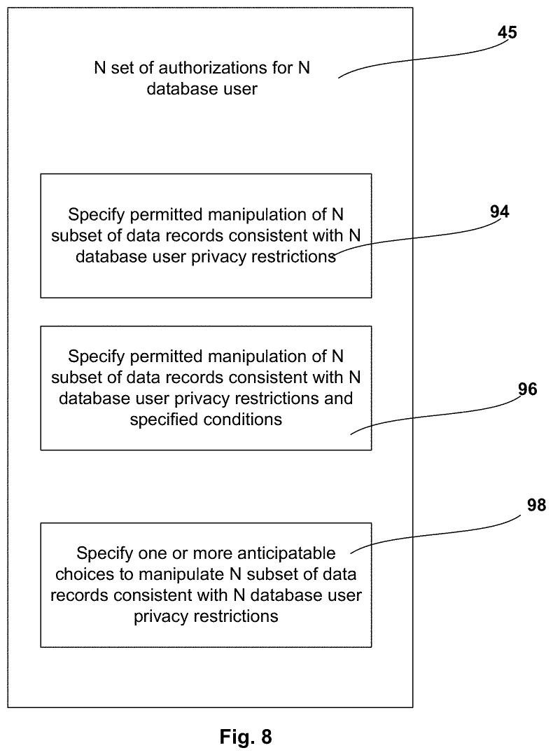

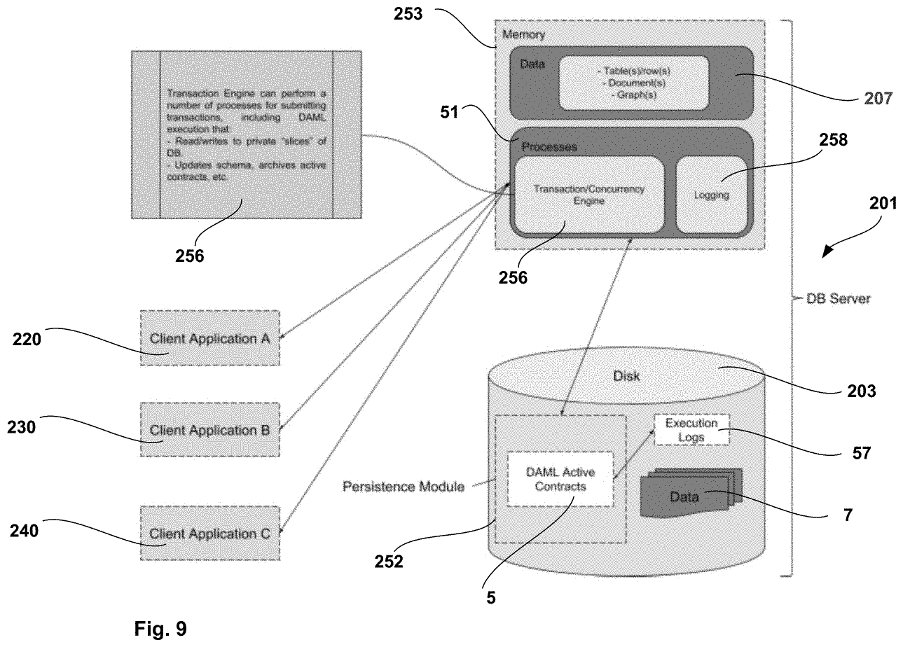

As described above, the programming semantic used in database system 1, in an example, can be a programming language created by the Applicant, referred to as DAML. A number of details surrounding DAML can be found in the DAML 2 and DAML 3 applications filed by the Applicant and incorporated by reference herein above. In an embodiment, execution engine 2 can be the mechanism by which DAML programs 51 are executed by database users 21, 31, 41 when submitting transactions 53 to database system 1. What follows below is a description of certain features of DAML relevant to database system 1, and how execution engine 2 (e.g., its runtime system and environment) executes DAML programs 51 to ensure database system 1 includes multi-party privacy, auditability, and proper authorizations. To illustrate the preceding, an example DAML program is provided in FIG. 7, and FIGS. 2-6 and 8 are used as supporting figures to illustrate the privacy and authorization aspects of DAML pertinent to database system 1.

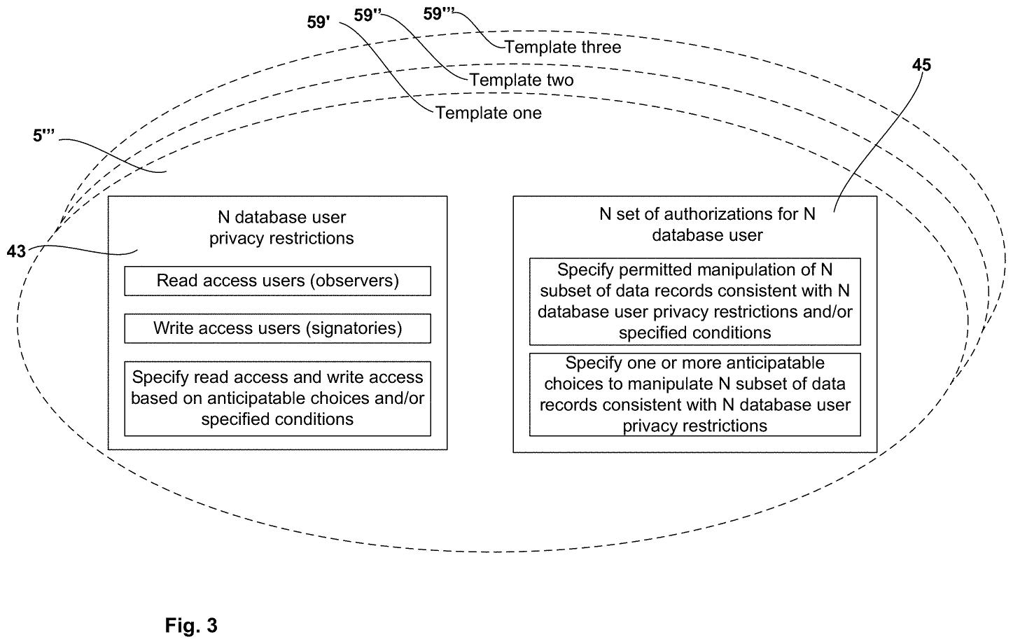

DAML programs can be expressed as a template or series of templates 59, 59′, 59″ (FIG. 3) and 81 (FIG. 7). In an example, a template can be referred to as a contract template or smart contract template. Templates 59, 59′, 59″, 81 can define data schema 196 in addition to code declaration or logic (e.g., choices 83, 85) that can manipulate or access data of a data schema 196. Thus, a template 59, 59′, 59″, 81 can be conceptually thought of as an un-instantiated program that can define data schema along with code declaration or logic, which acts to define how multiple parties can use and/or access the program. An instantiated version of a template 59, 59′, 59″, 81 can be referred to as a contract or smart contract. Both templates 59, 59′, 59″, 81 and their instantiations can be recorded to the persistence module of database system 1 for later execution by database users 21, 31, 41.

### Authorization, Privacy, and Validation

DAML semantics, along with the enforcement of those semantics by execution engine 2, can define a privacy model 13 and an authorization model 19 (FIG. 2) for a DAML program(s) among different database users 21, 31, 41. For instance, a DAML program such as template 81 of FIG. 7 can define different Parties (e.g., each associated with a unique cryptographic identity such as a private/public key pair) and execution engine 2, during execution of an instantiation of template 81 (e.g., by way of its runtime system), can enforce shared privacy restrictions 14 and shared authorizations 20 amongst those different Parties. In the case of database system 1, the different Parties can be any of database users 21, 31, 41.

Stated differently, database users 21, 31, 41 can compose DAML templates 59, 59′, 59″, 81 in a myriad of ways using the DAML language and the semantics of DAML, as enforced by execution engine 2, can ensure that a privacy model 13 that includes privacy restrictions 14 associated with any subset of database users 21, 31, 41 (FIG. 2) is enforced. In an example, a subset of database users can, in DAML, define a first database user 21's privacy restrictions 23′, 33′, 43′, a second database user 31's privacy restrictions 23″, 33″, 43″, and any additional N database user's privacy restrictions 23′″, 33′″, 43′″ to collectively define the group's privacy restrictions 14 for a specific DAML program(s). Privacy restrictions 14 might specify each first 21, second 31, and N database user's read and/or write access to specific data records 7 of database system 1. Privacy restrictions 23′, 23″, 23′″ might be evidenced in database system 1 as authorized by database user 21, privacy restrictions 33′, 33″, 33′″ might be evidenced in database system 1 as authorized by database user 31, and privacy restrictions 43′, 43″, 43′″ might be evidenced in database system 1 as authorized by database user 41. In this description, reference to ‘N’ (such as ‘N database user’, ‘N set of authorizations’, ‘N user’ or ‘N subsets of data records’) is used to denote an unspecified member or item in a series or plurality.

In addition, database users 21, 31, 41 can compose DAML templates 59, 59′, 59″, 81 so that instantiations of a template 59, 59′, 59″, 81 conform to an authorization model 19 that includes authorizations 20 to run parts of the instantiated DAML program(s) by certain of database users 21, 31, 41. In an example, a subset of database users can, in DAML, define a first database user 21's authorizations 25′, 35′, 45′, a second database user 31's authorizations 25″, 35″, 45″, and any N database user's authorizations 25′″, 35′″, 45′″ to execute defined parts of the instantiated DAML template 59, 59′, 59″, 81. Authorizations 25′, 25″, 25′″, 35′, 35″, 35′″, 45′, 45″, 45′″ can permit the database users to execute certain parts of the DAML program and thereby access and/or manipulate 54′, 54″, 54″, 55′, 55″, 55′″, 56′, 56″, 56′″, respectively, first 27, second 37, and N 47 subsets of data records stored in database system 1 (FIG. 2). Typically, the execution of parts of a DAML program is affected by database users 21, 31, 41 submitting transactions 53 to database system 1.

Any of privacy restrictions 23′, 23″, 23′″, 33′, 33″, 33′″, 43′, 43″, 43′″, can specify the respective database user's access (e.g., read, write, or no access) to data records 7 stored with database system 1 for all states of a particular DAML program(s). In addition, the privacy restrictions of a particular database user to data records 7 stored within the database system 1 can change as a DAML program is executed by system 1 and changes state. Changes to privacy restrictions can be anticipatable as such changes follow the rules defined within their corresponding DAML templates. For instance, a first database user 21 can have privacy restrictions 23′, 33′, 43′, according to the DAML semantics of the associated DAML template(s), that restrict user 21's access (e.g., read, write, or no access) to a first subset of data records 27 stored in database system 1, a second database user 31 can have privacy restrictions 23″, 33″, 43″, according to the semantics of the same DAML template(s), that restrict user 31's access (e.g., read, write, or no access) to a second subset of data records 37 stored in database system 1, and any N database user can have privacy restrictions 23′″, 33′″, 43′″ that restrict N users' access (e.g., read, write, or no access) to N subset of data records 47 stored in database system 1. Further, as detailed more fully elsewhere in the description, as transactions 53 are submitted by first 21, second 31, or N database users to database system 1 (e.g., database server 9), any of privacy restrictions 23′, 23″, 23′″, 33′, 33″, 33′″, 43′, 43″, 43′″ can be altered as the associated DAML program state and/or the state of data records 27, 37, 47 changes.

In addition, any of authorizations 25′, 25″, 25′″, 35′, 35″, 35′″, 45′, 45″, 45′″ can specify, inter alia: (i) a database user's ability to execute certain parts of an instantiated DAML program, (ii) the database user's ability to delegate execution of such part of the DAML program to another database user(s), (iii) the ability for other database users to execute parts of DAML programs that would impact the database user, and/or (iv) the ability of the database user to access and/or manipulate specific subsets of data records in database system 1. In addition, as with privacy restrictions, authorizations of a particular database user to do any of (i) to (iv) can change as a DAML program is executed by system 1 and changes state. For instance, a first database user 21 can have authorizations 25′, 35′, 45″, according to the DAML semantics of the associated DAML template(s), that define user 21's authorizations to do any of (i) to (iv), a second database user 31 can have authorizations 25″, 35″, 45″, according to the DAML semantics of the same DAML template(s), that define user 31's authorizations to do any of (i) to (iv), and any N database user can have authorizations 25′″, 35′″, 45′″ to do any of (i) to (iv). Further, as detailed more fully elsewhere in the description, as transactions 53 are submitted by first 21, second 31, or N database users, any of authorizations 25′, 25″, 25′″, 35′, 35″, 35′″, 45′, 45″, 45′″ can be altered as the associated DAML program state and/or the state of data records 27, 37, 47 changes. In some examples, this can include a transaction 53 submitted by one database user that changes another database user's access to the other database user's subset of data records and/or authorizations to manipulate the subset of data records.

Privacy restrictions 23′, 23″, 23′″ and authorization sets 25′, 25″, 25′″ might be evidenced in database system 1 as authorized privacy restrictions and authorization by database user 21 toward itself and toward users 31 and 41. Privacy restrictions 33′, 33″, 33′″ and authorization sets 35′, 35″, 35′″ might be evidenced in database system 1 as authorized privacy restrictions and authorization by database user 31 toward itself and toward users 21 and 41. Privacy restrictions 43′, 43″, 43′″ and authorization sets 45′, 45″, 45″ might be evidenced in database system 1 as authorized privacy restrictions and authorization by database user 41 toward itself and toward users 21 and 31.

A concrete example illustrating the above aspects of the disclosure is useful. Referring to FIG. 7, template 81 is an example of a Cash template whose potentialRecipients field 74 can be seen as the list of potential recipients of a cash amount 76. Template 81 uses the semantic DAML keyword “signatory” to specify that an issuer 197—a field of the Party type—must be a signatory of an instantiation of template 81 for it to be valid, and the keyword “observer” to specify that potentialRecipients 74—a List (e.g., array) of the Party type—are observers to an instantiation of template 81. In an example, the “observer” keyword can signify that Parties (here, potentialRecipients 74) listed as observers only have read access to any data records 7 associated with instantiations of template 81 that are stored with database system 1. Such data records 7 can conform to data schema 196. For instance, an instantiation 75 of template 81 (e.g., a data record 7 in the form of a row 75 in a table of a relational database system 1) is shown at the top of FIG. 7, and it can be seen that observers 79 are listed as a column in that data record. In this example, listing observers 79 with instantiation 75 would indicate that the potentialRecipients (donor 80) have read-only access to that data record (row 75). Unless also provided with additional rights in the particular DAML program, the potentialRecipients (donor 80) in this example would have privacy restrictions related to the data record in FIG. 7 limited to read-only access and no authorization to change or mutate the data record. Thus, for example, any transaction 53 submitted by a database user related to donor 80 attempting to mutate any data within row 75 can be failed (e.g., at runtime by execution engine 2 as detailed below) to enforce the aforementioned restrictions on donor 80.

Conversely, the “signatory” keyword mentioned above can, in an example, signify that a Party(ies) (here, issuer 197) has read access to instantiations of template 81, but also that the Party(ies) must cryptographically authorize instantiations of template 81 (and database system 1 must be able to evidence instantiation of template 81 to a by Party) for the instantiation to be valid within database system 1. For instance, clearly as shown at the top of FIG. 7, bank 78 needs to cryptographically authorize the instantiation 75 of a Cash contract in database system 1 for it to be valid. Indeed, if bank 78 has not cryptographically authorized the creation of a Cash contract, then it cannot be obligated to provide an amount 76 of cash as specified in the code declaration (choices 83, 85) of the contract. Here, in this example, signatories 77 can also be listed as a column of instantiation 75 (row). As mentioned previously, cryptographically authorizing an instantiation of template 81 can include cryptographically signing a transaction 53 that has the effect of instantiating template 81 and persisting that instantiation within database system 1. Cryptographically authorizing an instantiation of template 81 can also include signing evidenced data.

Thus, the semantics of DAML—in this case the “signatory” and “observer” keywords—can dictate certain privacy restrictions and authorization constraints for different database users, which can be enforced during execution of the specific DAML program by execution engine 2. For instance, it could be the case that database user 21 is associated, by a unique cryptographic identity recorded to database system 1, with bank Party 78 of instantiation 75 of template 81 shown in FIG. 7. And, it could be the case that database user 31 is associated, by a unique cryptographic identity recorded to database system 1, with donor Party 80 of instantiation 75 of template 81. As such, privacy restrictions 23′, 23″ for database user 21 can comprise the fact that database user 21 has, by virtue of being a “signatory” 77, at least read access to instantiation 75 of template 81, and also authorization constraints that database user 21 must have cryptographically authorized instantiation 75 (e.g., be accountable for the instantiation) for it to be a valid entry as a data record 7 in database system 1. Further, privacy restrictions 23″ for database user 31 can comprise the fact that database user 31 has, by virtue of being an “observer” 79, at least read access to instantiation 75 of template 81. In addition, database user 31 can rely on DAML semantics, as enforced by execution engine 2 when a DAML program is executed, to ensure database user 21 has cryptographically authorized instantiation 75 of template 81, thereby giving confidence to database user 31 that instantiation 75 is a valid entry or data record 7 (and thus obligation) in database system 1. For instance, database user 31 could be confident that it holds amount 76 of cash represented as a data record 7 in database system 1 and that database user 21 is accountable for this state due to the authorization constraints built into the semantics of DAML.

Further authorization constraints can be built into the semantics of DAML and enforced within database system by execution engine 2. Examples of such authorization constraints are discussed below in connection with the Cash template 81 of FIG. 7. Broadly speaking, any of the authorization constraints or features of DAML 2 or DAML 3 can be utilized with database system 1 and enforced by execution engine 2 to ensure that transactions 53 submitted to database system 1 are appropriately cryptographically authorized by the relevant database user 21, 31, 41. For instance, so called “obligable computation” authorization constraints (sometimes referred to as non-obligable computational checks), disclosed in DAML 3 in ¶s [219] to [231], can be utilized with database system 1 to ensure that all possible execution paths of a DAML program(s) used with database system 1 are authorized by the correct database users 21, 31, 41. Indeed, DAML 3 details how, during execution of a DAML program, it can be ensured that all execution paths or possibilities of that program are well authorized. This can be the same for database system 1, and execution engine 2 can be the mechanism to enforce such authorization constraints. For instance, execution engine 2, by way of its runtime system and/or environment, can examine all execution paths of a DAML program(s) (e.g., prior and future execution states) stored in database system 1 to ensure that each prior execution path or state of the program(s) and each future execution path or state of the program(s) is appropriately cryptographically authorized.

Using Cash template 81 as an example of authorization constraints, it can be seen that template 81 includes multiple choices 83, 85 that can be executed by owner 84. In an example, the semantics of DAML—in this case the use of the keywords “controller owner can”—dictate authorization constraints that can be enforced by execution engine 2 upon instantiation of template 81. The “controller can” syntax, when interpreted and executed by execution engine 2, can indicate that only the designated Party(ies) (here, owner 84) is authorized to execute the relevant code declaration or logic (e.g., the body of choice 83 in FIG. 7). In an example, the Party(ies) provided with such ability can demonstrate its authorization to execute the relevant code declaration or logic (e.g., the body of choice 83 in FIG. 7) by cryptographically signing a transaction 53 submitted to database system 1 with an appropriate cryptographic key (e.g., a unique private key). In addition, the body of relevant code declaration and logic can specify further authorization constraints, which can include the ability to ensure that, within the code declaration and logic (e.g., choice 83), the relevant Party(ies) cannot create new DAML programs binding other Party(ies) to an obligation without such Party(ies) authorization, cannot exercise (i.e., progress execution) parts of other DAML programs without proper authorization, and cannot archive or otherwise modify other data and shared code segments associated with DAML programs without proper authorization. In an example, execution engine 2 can perform so-called “obligable computation” checks to ensure that none of the preceding exemplary authorization constraints of DAML are violated. In FIG. 7, it can be seen that “Cash” contracts (DAML template 81) can only be initially created through an operation cryptographically authorized by “issuer” Party (within 196), as this Party is a signatory 197. Note that in this example, once created the “issuer” stays the same over any of the executable choices 83, 85, allowing the initial authorization of “issuer” to authorize the Cash contract creations 89, 87 and 95. Likewise, exemplary DAML semantics makes controller “owner” 84 an observer, and authorizes “owner” party to execute the choices 83, 85.

Thus, the semantics of DAML can be used by any database users 21, 31, 41 to compose DAML programs and ensure that appropriate privacy restrictions and authorization constraints are enforced between users 21, 31, 41. As detailed below, execution engine 2 can play an important role in ensuring that privacy restrictions and authorization constraints are enforced in database system 1 when a DAML program is executed within database system 1.

### Evidence Log

Database system 1 can use a database evidence log 57 to record an execution history of shared code segments (e.g., the execution of instantiated DAML templates), submitted transactions 53, cryptographic authorizations associated with transactions 53, and other information useful as evidence or for auditing database system 1. In some examples, this can include evidence of validation of privacy restrictions and/or authorizations. In other words, evidence that execution of an instantiated DAML template conforms to any associated privacy model and/or authorization model.

Evidence log 57 (also referred to herein as an “audit log”) can include auditable information for database users 21, 31, 41 to validate the state of database system 1 according to the different (and permitted) views of each database user. It is to be appreciated that in further examples, this may also allow a database server 9 and other parties to validate the state of database system 1 in accordance with privacy restrictions and authorizations.

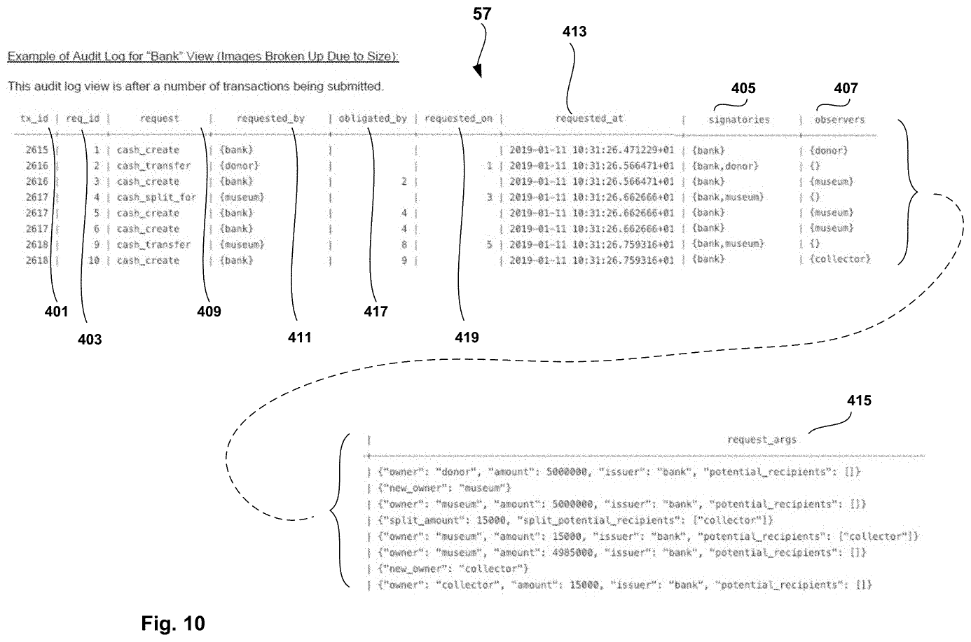

An example of an evidence log 57 is illustrated in FIG. 10, which shows evidence of a number of transactions 53 that have been submitted. Evidence log 57 may capture one or more of the following data:
1. A globally-unique transaction identifier (“tx_id” 401).
2. A request identifier for the request that caused insertion, deletion, or update of particular data records 7 (“req_id” 403). The request identifier can identify particular data records.
3. Signatories and observers to the request (“signatories” 405 and “observers” 407). This can include:
   a. The party (e.g., database user) authorizing the request.
   b. The parties authorizing execution of the one or more shared code segments executed as a result of the execution request.
   c. The parties authorizing observer read access of specific parties to particular data records.
   d. The parties authorized with read access to observe data affected (inserted, updated, or deleted) by the request.
4. The request type (“request” 409) and an identification of the requestor (“requested_by” 411). The request type can be a reference to the shared code segment(s) 51, 5 (e.g., DAML contract(s) and/or templates 59) called by the request. For instance, the request type can be a DAML contract template identifier, which can be an identifier of a DAML program (discussed below).
5. A request timestamp (“requested_at” 413), such as a timestamp of submission of a transaction 53. Exemplary timestamp value can be set by database operator or by a separate timestamping engine 8.
6. The request arguments used to invoke the DAML contract(s) (“request_args” 415).
7. A reference to any request that may have initiated the current request for a transaction (“obligated_by” 417). For example, if a prior request for a transaction initiates the execution of a delegated request for a transaction (e.g., the current request), then audit log 57 can store the request identifier of the prior request that initiated the current, delegated request. An example is request 3 that is “obligated by” previous request 2.
8. A reference to any previous request (“requested_on” 419) that may have enabled authorization and privacy constraints permitting progress of execution through the current request. For instance, request 4—“cash_split_for”—was possible given request 3—the request that created a cash amount of 500,000 owned by owner “museum”—and therefore request 4 references request 3.
9. Other audit data not shown that would be necessary for a party to validate the current state of database system 1 according to its privacy view.
10. Other data not shown that would be necessary for an operator to shard, partition, cluster, index, and generally to orchestrate parallel and sequential execution for greater speed, lower latency, and best power consumption of database operations.

Database system 1 can ensure that all database transactions have proper evidence. Recorded evidence can be associated to each transaction as part of each transaction. In other words, transaction and concurrency engine 6, execution engine 2, and evidence log 57 can process together and commit each portion of evidence to evidence log 57 together with committing the evidenced transaction and evidenced database operations. Database system 1 can ensure that no transaction or database operation is committed without evidence, and no portion of evidence log 57 is recorded without the database recording the corresponding evidenced transaction and operations.

The database transaction and concurrency engine 6, execution engine 2, and evidence log 57 can be used to determine which transactions 53 submitted to database system 1 are valid and can be committed with evidence in. If committed, a transaction 53 can both result in the execution of a DAML program(s) 51, or part thereof, on behalf of one or more database users 21, 31, 41 and result in a portion of evidence log 57 evidencing the validity of transaction 53. Evidence within evidence log 57 can be viewed by one or more database users subject to the evidenced transactions privacy and authorization constraints, thereby allowing multi-party definition and evidenced execution of programs 51 using database system 1. Evidenced transactions 53 can, in some cases, have the effect of manipulating data records 7, evolving database schema, or performing other database actions, thereby allowing multi-party evidenced data records 7 used across multi-party programs 51.

Database system 1 query operations can produce evidence results. A database user can request a database transaction 53 that commits results that depend on the presence or the absence of specific evidence log 57 data. Database authorization can authorize execution of specific program segments conditional to the presence or absence of specific evidence result within the program's query operations to the evidence log 57 data. Database authorization can authorize execution of specific program segments conditional to the creation of specific evidence result within the program's operations. An exemplary evidence log 57 implementing DAML semantics can record authorized and evidenced transaction results, authorizations, and data, allowing one or more database users 21, 31, 41 to authorize transactions that authorize program execution conditional to the presence or absence of previous or current transaction results.

Database system 1 can ensure that an execution authorization for a specific program segment can be conditional to the presence, within the transaction that is expecting to execute the specific program segment, of specific operations on data, or authorization, or specific execution operations. Database users frequently rely on such transaction-wide conditions to manage data within groups of database users, where database users can be free to operate on data within a specific group of database users, but must include specific authorizing database users for transactions that include out-of-group database users.

Database system 1 may include constraints to ensure the privacy of evidence log 57 according to each database user's specific “view”. In other words, each database user can only view the portion of audit log 57 applicable to its own access authorizations to data records 7. As such, any database user, in an example, is not privy to audit log 57 information relevant to other database users unless permitted according to DAML semantics, as detailed above. This practically means that database users can verify the state of database system 1 only as it pertains to their permitted view.

Database system 1 may include use of dedicated secure hardware features (e.g., a trusted-execution environment or secure enclave, such as Intel SGX) to attest that evidence within, and returned by a query from, the evidence log 57 are the results of execution and storage with the use of an authenticated version of database system 1, and an authenticated version of the evidence log 57. In other words, through the use of dedicated secure hardware features, an authenticated version of a correct database system 1 implementing the shared database program semantics (e.g., DAML semantics), including an authenticated correct evidence log program, can attest to each user correct private and authorized execution of database transactions entered into the evidence log by the user, and queried from the evidence log 57 by the user.

### Exemplary Method(s)

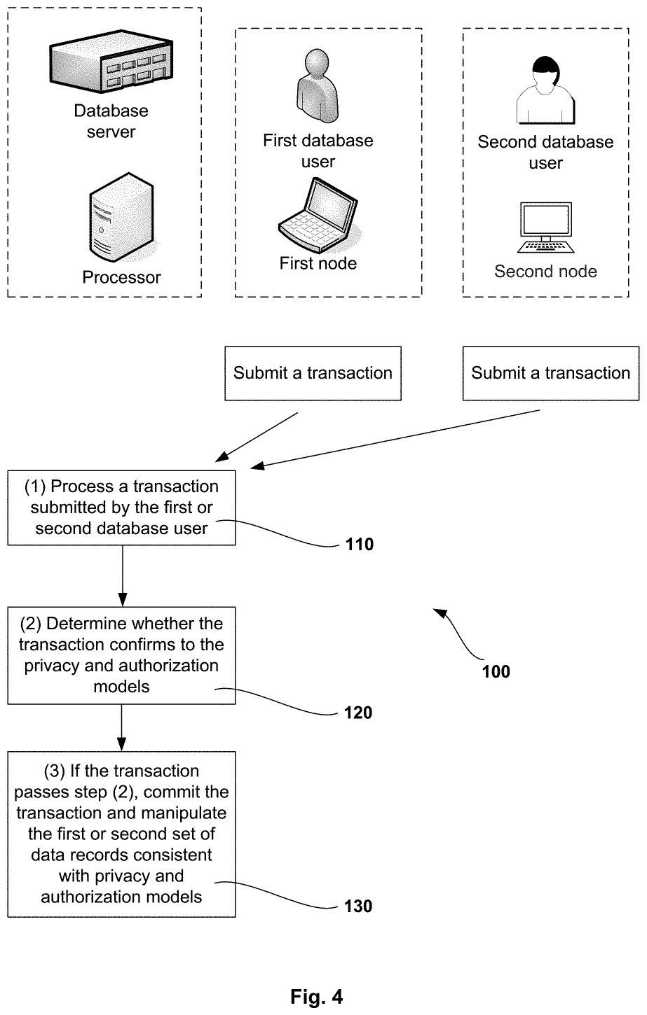

Referring to FIGS. 1 and 4, first 21, second 31, and any N 41 database users can agree on first 59′, second 59″, and third 59′″ DAML templates defining the users' DAML program for a particular use case. For instance, first 59′, second 59″, and third 59′″ DAML templates could define a DAML program for conducting an exchange of digital assets over a computer network. First 59′, second 59″, and third 59′″ DAML templates can be persisted to database system 1 via the persistence module (e.g., stored in memory 3) as executable program instructions 51. In an example, first 21, second 31, or N 41 database user can submit a transaction 53 to database system 1 in the form of a request with a payload corresponding to first 59′, second 59″, and third 59′″ templates to persist such templates to memory 3 for execution at a later point.

DAML templates 59′, 59″, 59′″ can define privacy 13 and authorization 19 models amongst database users 21, 31, 41. Indeed, as described in detail above, the semantics of DAML can allow database users 21, 31, 41 to compose DAML programs and define privacy 13 and authorization 19 models or constraints for their particular use case (e.g., here, the exchange of digital assets over a computer network). In an example, one of templates 59′, 59″, 59′″ could be Cash template 81 of FIG. 7 and the digital asset being exchanged could be a digital representation of an amount 76 of cash, as set forth in that template 81. As shown in FIG. 2, DAML templates 59′, 59″, 59′″ can define privacy restrictions 23′, 23″, 23′″ and a first set of authorizations 25′, 25″, 25′″ authorized by a first database user 21, privacy restrictions 33′, 33″, 33′″ and a second set of authorizations 35′, 35″, 35′″ authorized by a second database user 31, and privacy restrictions 43′, 43″, 43′″ and an N set of authorizations 45′, 45″, 45′″ authorized by an N database user. FIG. 3 illustrates database users' 21, 31, 41 privacy restrictions 14 and authorizations 20 defined by templates 59′, 59″, 59′″. Authorizations 20 can be any of (i) to (iv) described herein in ¶ [80], and privacy restrictions 14 can specify read and/or write access to subsets 27, 37, 47 of data records 7 stored in database system 1 consistent with a user's respective within authorizations 25, 35, 45. For instance, any of users 21, 31, 41 may have authorization to execute some code declaration or logic (e.g., a “choice”) in a DAML template, and such user's privacy restrictions can define that user's ability to read and/or write to a specific subset of data records 7 during and/or after execution of the code declaration or logic.

To access and/or manipulate data records 7 in database system 1, any of database users 21, 31, 41 can submit transactions 53 to database system 1. A transaction 53 can be a request sent by a computer or node 20, 30, 40 of any of users 21, 31, 41 over a communication network (e.g., the Internet) to database system 1 (e.g., database server 9) to access or manipulate any data record 7.

FIG. 5 illustrates an example of a transaction 53 submitted to database system 1 or server 9. In some examples, transaction 53 can include one or more requests or operations. For example, transaction 53 may include a request 61 to manipulate a subset of the data records 7 in accordance with privacy restrictions and set of authorizations defined therein. As described above, the privacy restrictions and set of authorizations may be defined by privacy model 13 and authorization model 19, respectively. Transaction 53 can also include a request 63 to manipulate a subset of the data records 7 in accordance with privacy restrictions and authorizations defined in Z template. In a further example, transaction 53 can include a request to manipulate a subset of the data records in accordance with a specified choice from a plurality of anticipatable actions. In yet a further example, transaction 53 can include a request to manipulate multiple subsets of the data records in accordance with respective privacy restrictions and sets of authorizations.

As shown in exemplary process 100 of FIG. 4, transactions 53 can be submitted to database server 9 and processed 110 by server 9. In an example, each transaction 53 can be a request to access or manipulate data records 7 stored with database system 1 or to execute an instantiated DAML template 59′, 59″, 59′″. Indeed, any of templates 59′, 59″, 59′″ can be instantiated (e.g., by submitting a transaction 53 to database system 1), thereby providing, depending on the template, the relevant users 21, 31, 41 the ability to execute code declaration or logic (e.g., “choices”) of the instantiated template(s) and/or access data defined in the data schema of the template(s). Upon submission of a transaction 53 to database server 9, transaction, concurrency and execution engines 6 and 2 can process 110 transaction 53 and order transaction 53 relative to other transactions 53 that might be submitted to database server 9 for processing. For instance, transaction and concurrency engine 6 can utilize any of the concurrency control protocols mentioned herein to order transaction 53 relative to other transactions 53 and ensure transaction 53 maintains important transactional properties (e.g., atomicity, consistency, isolation, and durability) as it is processed by database server 9.

Transaction, concurrency, and execution engines 6 and 2 can also process 120 transaction 53 to determine whether transaction 53 conforms to privacy 13 and authorization 19 models. If transaction 53 conforms to privacy 13 and authorization 19 models, transaction 53 can be committed and, as shown in FIG. 2, first 27 and/or second 37 subsets of data records 7 can be manipulated 55′, 55″ consistent with privacy 13 and authorization 19 models. For instance, in an example, transaction 53 can be a request transmitted by first 20 and/or second 30 computer nodes to execute an instantiated DAML template 59′, 59″, 59′″, which can have the effect of manipulating data records 7 stored in database system 1. Indeed, FIG. 10 illustrates that req_id 1—a transaction 53—is a cash_create request that acts to instantiate Cash template 81 of FIG. 7 as a data record 7 in database system 1. Likewise, req_id 2 is a cash_transfer transaction 53 that acts to execute second choice 85 (i.e., the transfer choice) of the instantiated Cash template 81 from the req_id 1 transaction 53. Execution of the transfer choice can cause the entry or manipulation of a data record 7 in database system 1 (e.g., a row in a table of a relational database) that records the transfer of cash (e.g., an amount 76 of cash) from a first database user to a second database user.

As mentioned above, if transaction 53 conforms to privacy 13 and authorization 19 models, transaction 53 can be committed. In an example, execution engine 2 can provide a mechanism to commit a transaction 53 to database system 1. For instance, the runtime system of execution engine 2 can act to execute an instantiated DAML template 59′, 59″, 59′″ and ensure that such execution conforms to privacy 13 and authorization 19 models of the particular instantiation. In an example, in response to a transaction 53, program instructions 51 corresponding to the instantiated DAML template 59′, 59″, 59′″ can be retrieved from the persistence module (e.g., memory 3) and executed using the runtime system of execution engine 2 by processor 11. If the particular transaction 53 requesting execution of the instantiated DAML template 59′, 59″, 59′″ contains parameters or other data necessary for the execution of the instantiated DAML template 59′, 59″, 59′″, such parameters or data can be provided to execution engine 2 during execution of the instantiated DAML template 59′, 59″, 59′″.

Further, execution engine 2 can ensure that privacy 13 and authorization 19 models are enforced during execution of such instantiated DAML template 59′, 59″, 59′″ (e.g., with the necessary parameters or data). For instance, when transaction 53 is submitted, data in the form of a cryptographic signature or a representation thereof by the computer node 20, 30, 40 that submitted the transaction request can be included along with transaction 53. And, upon execution of the instantiated DAML template 59′, 59″, 59′″, the runtime system of execution engine 2 can determine whether the computer node 20, 30, 40 that submitted transaction 53 is authorized to execute the instantiated DAML template 59′, 59″, 59′″. For instance, execution engine 2 can perform any of the authorization processes described in DAML 2 or 3, including so-called “obligable computation” authorization checks described in DAML 3 in ¶s [219] to [231]. If any of the related authorization sets 25′, 25″ 25′″, 35′, 35″, 35′″, 45′, 45″, 45′″ are violated by transaction 53, such that transaction 53 does not conform to authorization model 19, then execution engine 2 can fail execution of the instantiated DAML template 59′, 59″, 59′″ and exit the relevant process (e.g., with a message communicated to the computer node 20, 30, 40 submitting the transaction request). For instance, if an incorrect cryptographic signature is presented along with transaction 53, execution engine 2 can fail the execution of the instantiated DAML template 59′, 59″, 59′″ at runtime and not commit transaction 53 to database system 1. In another example, if a node 20, 30, 40 associated with transaction 53 has not provided appropriate authorization, execution engine 2 can fail the execution of the instantiated DAML template and not commit transaction 53 to database system 1.

Likewise, execution engine 2 can ensure that privacy model 13 is enforced during execution of an instantiated DAML template 59′, 59″, 59′″ (e.g., with the necessary parameters or data). For instance, any of privacy restrictions 23′, 23″, 23′″, 33′, 33″, 33′″, 43′, 43″, 43′″ can be altered with respect to related subsets of data records 27, 37, 47 and/or new privacy restrictions 14 can be created with respect to a different subset(s) of data records 7 during submission of a transaction 53 in which an instantiated DAML template 59′, 59″, 59′″ is executed using execution engine 2. Further, the alteration and/or creation of privacy restrictions applicable to different subsets of data records 7 can be dictated by how different database users 21, 31, 41 syntactically compose their DAML programs and how execution engine 2 (e.g., its runtime system) enforces that DAML syntax. For instance, template 81 of FIG. 7 illustrates a second choice 85 in which the owner “controller” can transfer an amount 76 of cash defined in the data schema of the template to another party, which acts to create another instantiation of template 81 where the owner 84 is set to a newOwner 95—a field of the Party type. Upon execution of transfer choice 85 of an instantiation of template 81, execution engine 2 can execute program instructions 51 corresponding to that choice 85 (e.g., by way of a transaction 53 submitted by the controller of the choice, donor 80), causing manipulation of data records 7 in database system 1 to show that amount 76 of cash was transferred from owner 84 to newOwner 95. In addition, execution of program instructions 51 related to the instantiation of template 81 can cause privacy restrictions for owner 84 and newOwner 95, who may correspond to database users, to change.

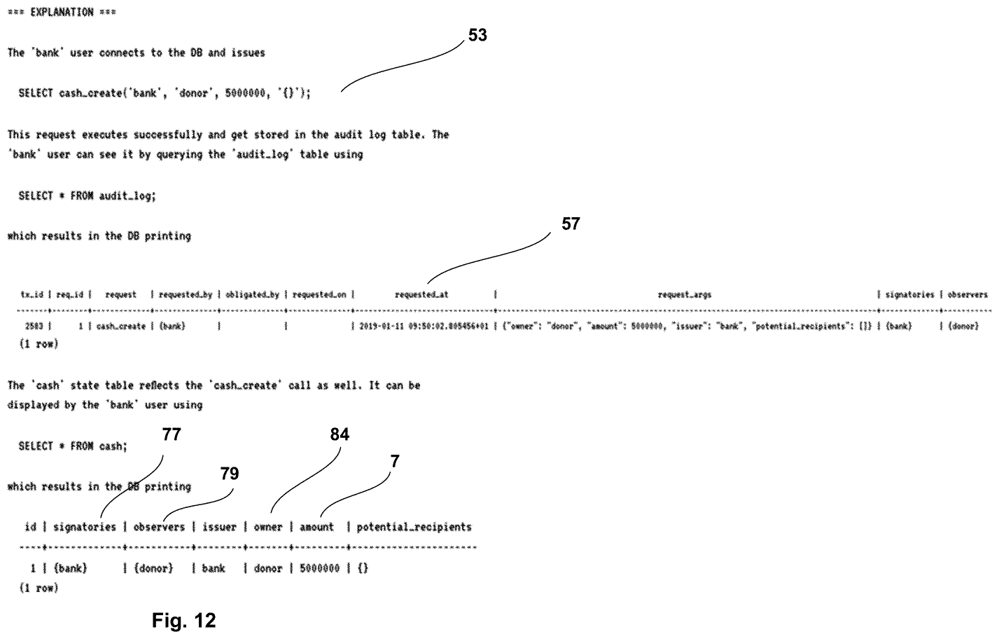

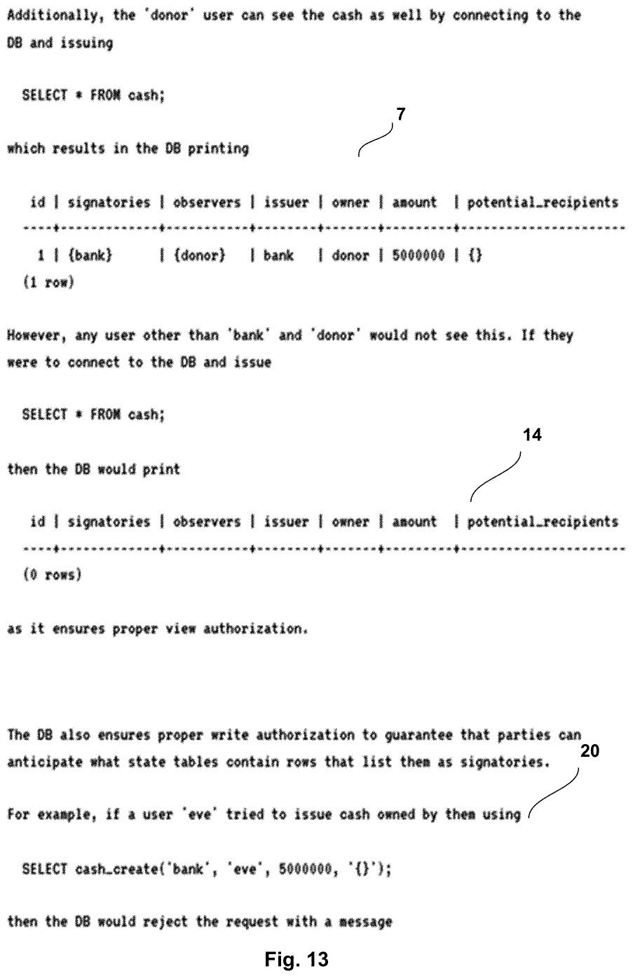

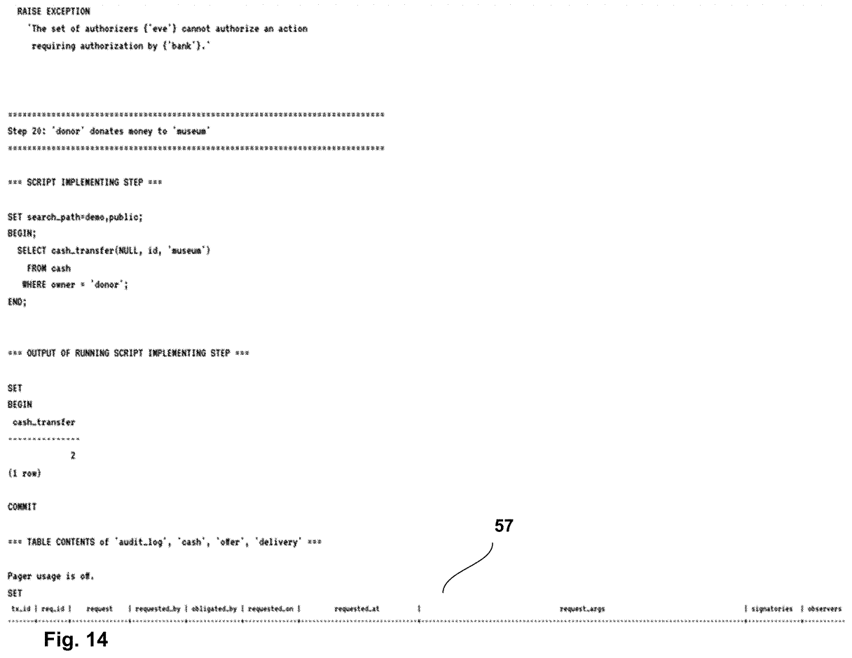

FIGS. 12-17 each illustrate an example output from the submission of a transaction 53 to database server 9 in which donor 80 executes second choice 85 of an instantiation of Cash template 81 to transfer amount 76 of cash from donor 80 to a newOwner 95, in this case a museum. In particular, FIG. 12 first illustrates a cash_create transaction 53 submitted by a bank database user, which results in database system 1 logging cash_create transaction 53 in evidence log 57 and entering details surrounding cash_create transaction 53 as a data record 7 (e.g., a row in a relational database) into system 1. Cash_create transaction 53, as shown, creates 500,000 in cash for owner 84, in this case donor 80. FIG. 13 illustrates the corresponding privacy restrictions 14 for the bank and donor parties, and for other database users who are not privy to cash_create transaction 53. Additionally, FIG. 13 and the top of FIG. 14 illustrates authorization constraints 20 for an instantiation of Cash template 81, in particular that a first database user (eve) cannot submit a transaction 53 to database server 9 that creates a cash obligation of 500,000 by a second database user (bank) without that database user's valid cryptographic authorization. Again, this is as a result of Cash template 81 specifying that a signatory 197 (issuer) must cryptographically authorize the instantiation of Cash template 81 for it to constitute a valid, binding obligation (e.g., cryptographically sign a cash_create transaction 53 that creates a cash obligation by the issuer). And as well the result of Cash template 81 specifying that a controller 84 (owner) is a cryptographically authorized observer with read access to the Cash data record 7.

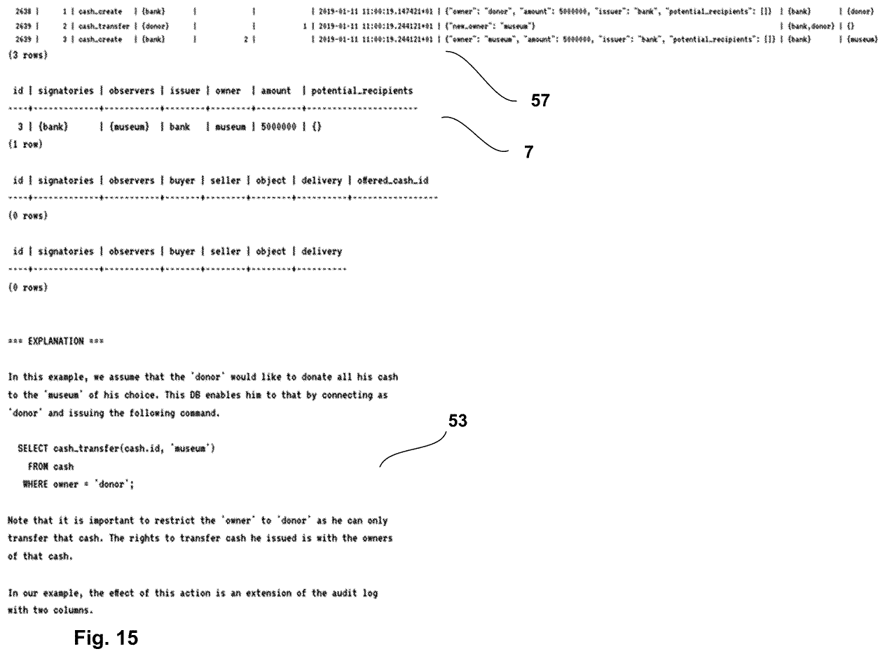

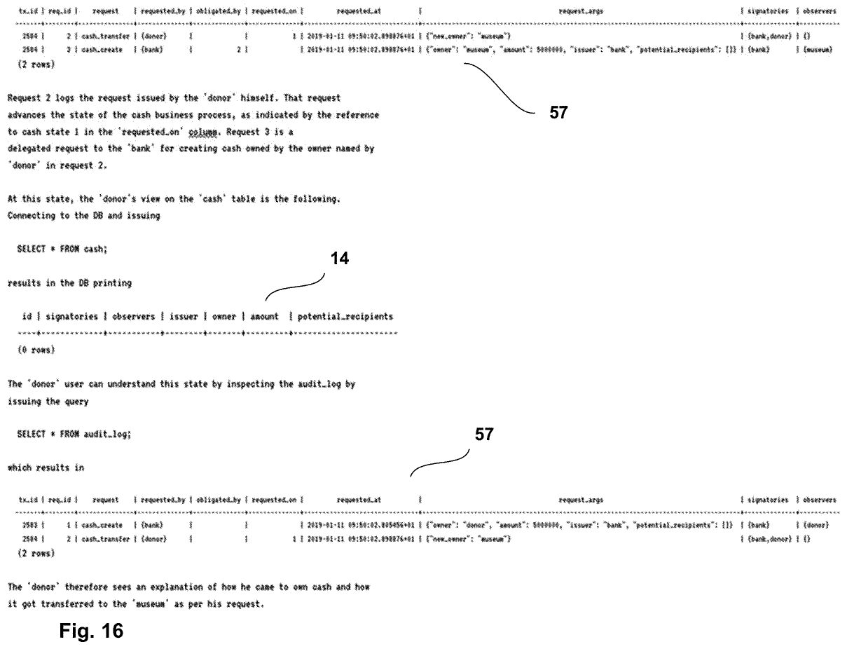

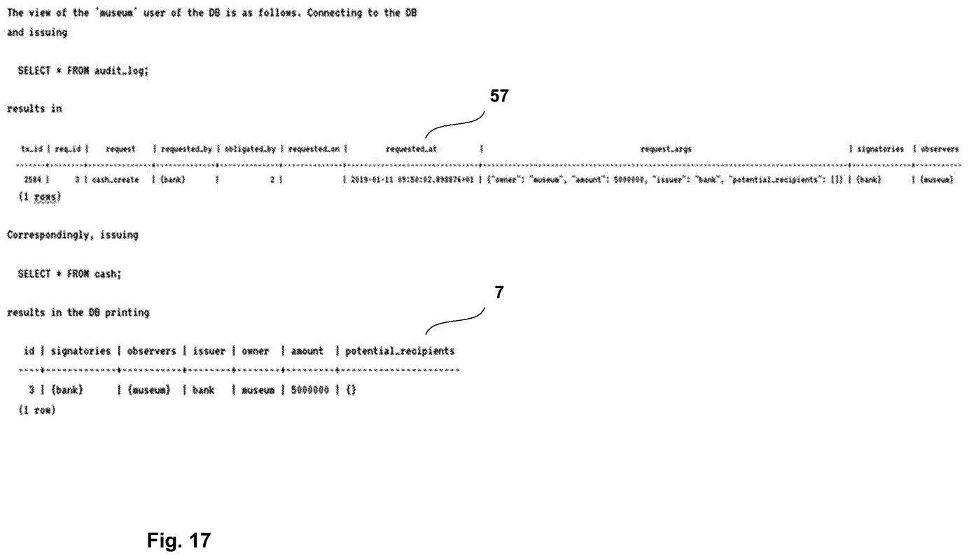

FIGS. 14-17 illustrates a transfer of cash by donor 80 to another database user, in this case a museum. FIG. 15 illustrates that donor 80 submits a cash_transfer transaction 53 to transfer amount 76 of cash from donor 80 to newOwner 95, in this case the museum. As shown at the top of FIG. 16, cash_transfer transaction 53 results in an extension of evidence log 57 by two (2) rows. Indeed, since cash_transfer transaction 53 effectively results in the execution of second choice 85 of the instantiation of Cash template 81, the addition of these two (2) rows is a logical and an anticipatable outcome of the execution of second choice 85. In particular, cash_transfer transaction 53 can result in a cash_transfer action that archives or retires the existing instantiation of Cash template 81, and a cash_create action that creates a new instantiation of Cash template 81 in which owner 84 is reflected as the museum. The new instantiation of Cash template 81 in which owner 84 is reflected as the museum can be seen in data record 7 at the bottom of FIG. 17 that is entered into database system 1 as a result of cash_transfer transaction 53. Further, FIG. 16 includes an explanation that the cash_create action that is part of request 3 is a delegated request to bank 78 for creating cash owned by the newOwner 95 (museum) specified by the previous owner 84 in the cash_transfer action. The reference to a delegated request can mean, as described in Applicant's DAML 3 application, that shared authorizations 20 exist between bank 78 database user and donor 80 database user in which donor 80 database user has delegated authorization to instantiate a Cash template 81 in the favor of a newOwner 95 in second choice 85 to bank 78 database user. In other words, donor 80 database user's execution of second choice 85 via a transaction 53 can delegate the creation of an instantiation of Cash template 81 in the favor of a newOwner 95 designated by the prior owner 84, in this case donor 80. For instance, in submitting a transaction 53 that executes second choice 85, donor 80 database user can provide along with such transaction 53 data that identifies newOwner 95 so that such data can be utilized during execution of second choice 85 by execution engine 2. As such, execution engine 2 (e.g., its runtime system) can ensure that the shared authorizations 20 between bank 78 database user and donor 80 database user are met during execution of second choice 85 and, if not met, execution engine 2 can fail any associated transaction 53. In particular, as reflected in evidence log 57 shown at the top of FIG. 16, donor 80's submission of a transaction 53 executing second choice 85 with newOwner 95 set to museum can result in a cash_transfer action, identified as request 2, and a delegated cash_create action in which bank 78 is identified as the requestor, resulting in the instantiation of a Cash template 81 with newOwner 95 listed as the museum. In addition, each of the aforementioned actions can occur within the same atomic transaction 53, identified as transaction 2584 in FIG. 16. Thus, either both of the actions occur or neither will occur, due to the atomic nature of transaction 53 submitted by donor 80 to transfer amount 76 of cash to newOwner 95, in this case the museum.

As also shown in FIG. 16, submission of the above transaction 53 by donor 80 database user can result in changing that database user's privacy restrictions 14. Indeed, since amount 76 of cash was transferred to newOwner 95 (museum), donor 80 database user no longer has the appropriate permissions to view that amount since it is not a party to the current instantiation of Cash template 81. As such, during execution of second choice 85, execution engine 2 can alter privacy restrictions 14 with respect to donor 80 database user, such that donor 80 no longer has the access authority to view any data records 7 associated with the current instantiation of Cash template 81. As illustrated in FIG. 16, donor 80 can audit and confirm that its privacy restrictions 14 are correct by viewing its version of evidence log 57, which displays only requests 1 and 2 that were part of transaction ids 2583, 2584. Notably, donor 80's view of evidence log 57 is also privacy-preserving in that it does not have a view into request 3, which is part of transaction id 2584 as donor 80 does not have appropriate privacy permissions to view that portion of the audit log. In addition, FIG. 17 shows the view of the museum both in terms of its evidence log 57 and its view into data records 7 stored in database system 1 that correspond to instantiations of Cash template 81. As illustrated, the museum only has a view into request 3 that was part of transaction id 2584, and a data record 7 that shows the museum has 500,000 in cash with bank 80 database user as the signatory.

As demonstrated through the above example, database system 1 and its execution engine 2 enforces privacy restrictions 14 and authorization constraints 20 amongst different database users, which can both be changed as different database users submit transactions 53 to database server 9. In addition, data corresponding to transactions 53 submitted to database system 1 can be captured in an evidence log 57 that also conforms to privacy restrictions 14 shared between different database users. The result is a multi-party database system 1 that is privacy and authorization preserving, and is auditable by all database users.

### Alternative Stored Procedures Implementation

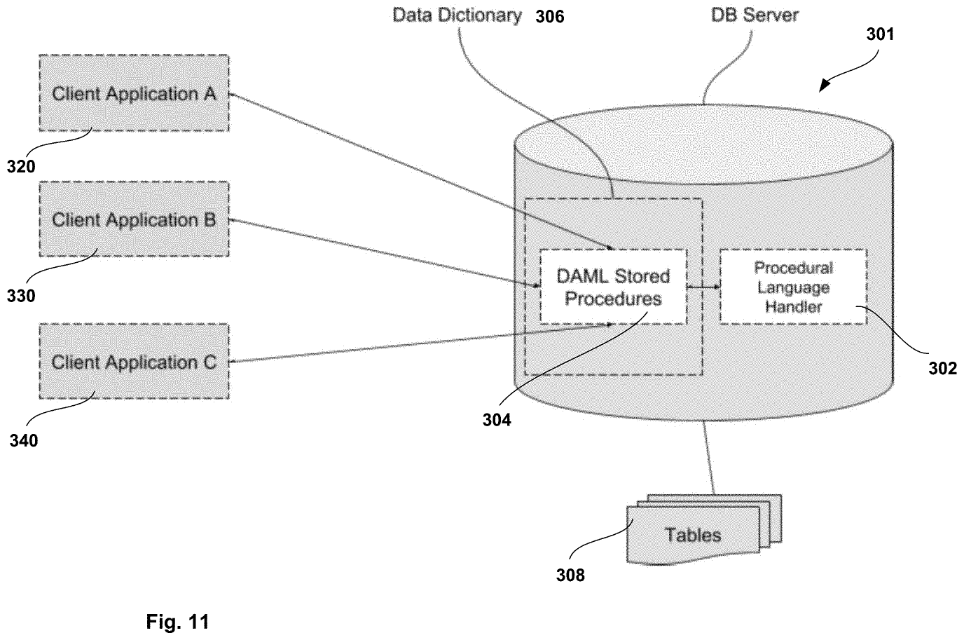

FIG. 11 illustrates an alternative stored procedures implementation of a database system 301, similar to database system 1 above. Although not discussed in detail herein, database system 301 can share many of the components and functions of database system 1, including but not limited to use of an execution engine 2 and evidence log 57.

In an example, DAML can be used as a procedural language for interaction with database system 301 and DAML templates and/or their instantiations can be stored in the database server of database system 301 as stored procedures 304. In an example, DAML stored procedures 304 can be stored in a data dictionary of database system 301. Further, a procedural handler or procedural language handler 302 can be included with database system 301. Procedural language handler 302 can comprise program instructions that parse, complete syntax analysis, and execution of a DAML stored procedure 304. Thus, procedural language handler 302 can comprise program instructions stored with the database server of database system 301, which act to interpret DAML contracts composed between different database users and take action in database system 301 (e.g., access and/or manipulate data records, for instance tables 308).

Similar to as described above with database system 1, data records stored in database system 301 can be accessed and/or manipulated by submitting transactions to the database server of database system 301, which have the effect of executing DAML stored procedures 304. As illustrated in FIG. 11, any number of client applications 320, 330, 340 can submit transactions to the database server of database system 301, which can act to execute a DAML stored procedure 304 between different database users. In an example, client applications 320, 330, 340 can cryptographically sign transactions submitted to the database server of database system 301 to evidence such applications' authorization to execute a particular stored procedure. Thus, as with the DAML examples discussed above, shared authorizations can exist between database users of database system 301 in the same manner as database system 1. Further, upon execution on a DAML stored procedure 304, privacy restrictions between database users of database system 301 can be enforced in the same manner as database system 1. Thus, database users can choose to compose their DAML programs as stored procedures 304 in a myriad of ways, and then submit transactions to the database server of database system 301 to execute such stored procedures 304 and cause privacy and authorization preserving access and/or manipulation of data records (e.g., tables 308) consistent with such transactions. In addition, although not shown, data pertaining to such transactions can be recorded in an evidence or audit log stored with database system 301 as detailed previously. Database system 301 can therefore provide an alternative multi-party private, auditable, and authorization-preserving database implementation to database system 1.

In an alternative embodiment, a programming language other than DAML can be used as the stored procedures language.

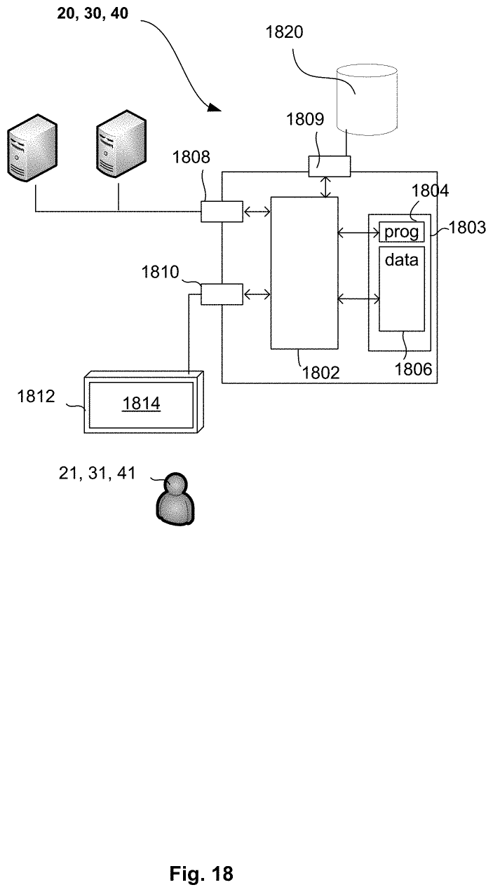

### Example Processor

[1] FIG. 18 illustrates an example node. The node 20, 30, 40 shown in FIG. 18 includes a processor 1802, a memory 1803, a network interface device 1808, an interface device 1809 that interfaces with a data storage device 1820 and a user interface 1810. The memory stores instructions 1804 and data 1806 and the processor performs the instructions from the memory to implement the methods as described above.

[2] The processor 1802 performs the instructions stored on memory 1803 and/or data storage device 1820. Processor 1802 receives an input by a user such as database users 21, 31, 41. Processor 1802 determines an instruction based on the input by a database user. The instruction may be a function to execute. The processor 1802 may execute instructions stored in the program code 1804 to indicate any output or result to the user 21, 31, 41.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

As an example and without limitation, although cryptographic authorization (e.g., cryptographic signature) is discussed in the disclosure, it is to be appreciated that other authorization mechanisms can be used with database system 1, including the submission of transactions 53 by database users. For instance, database users can authenticate themselves through non-cryptographic means (e.g., through the use of login credentials and/or a password) and then authorize transactions 53 using such non-cryptographic means.

In addition, although above in the disclosure a database server 9 is disclosed, it is to be appreciated that multiple database servers can be used in database system 1. Such multiple database servers can be combined with a controller to commit joint transactions between the multiple database servers.

1. A database system comprising:
a database system memory storing a database of data records and shared program instructions between first and second database users, wherein the shared program instructions define a privacy model comprising privacy restrictions for the first and second database users, respectively, and specify an authorization model comprising a first set of authorizations that permit the first database user to manipulate a first subset of the data records consistent with the first user's privacy restrictions and a second set of authorizations that permit the second user to manipulate a second subset of the data records consistent with the second user's privacy restrictions;
at least a first database server including a processor configured to execute the shared program instructions, wherein the shared program instructions, when executed by the processor:
1. process a transaction submitted by the first or second database user;
2. determine whether the transaction conforms to the privacy and authorization models; and
3. if the transaction passes step 2, commit the transaction and manipulate the first or second subset of data records consistent with privacy and authorization models.

2. A database system according to claim 1, further comprising program instructions stored with the memory that, when executed, validate that the transaction includes a cryptographic authorization from the first or second user consistent with the authorization model.

3. A database system according to claim 2, wherein the cryptographic authorization comprises the transaction being cryptographically signed by the first or second database user.

4. A database system according to claim 1, further comprising an evidence log and program instructions stored in the memory that, when executed by the processor:
record an execution history of the shared program instructions;
record a request to submit the transaction; and/or
record any cryptographic authorizations submitted along with the transaction.

5. A database system according to claim 4, further comprising an execution engine including program instructions that, when executed by the processor:
validate that the privacy restrictions for the first or second database user and the first or second set of authorizations conform to respective global rules for the database system; and
record evidence of validation of the privacy restrictions and authorizations in the evidence log.

6. A database system according to claim 1, further comprising a transaction and concurrency engine having program instructions that, when executed by the processor, use a concurrency control protocol to process concurrent transactions submitted to the database system.

7. A database system according to claim 1, wherein the shared program instructions are, at least in part, stored procedures stored in the memory, and the system further comprises a procedural handler configured to:
determine, from the transaction submitted by the first or second database user, one or more stored procedures suitable to process the transaction; and
process, at least in part, the transaction by executing the one or more stored procedures.

8. A database system according to claim 1, further comprising an execution engine configured to execute the shared program instructions and enforce the privacy and authorization models.

9. A database system according to claim 8, wherein the execution engine is configured to limit access to the data records in a manner consistent with the privacy model.

10. A database system according to claim 8, wherein the execution engine is configured to execute the shared program instructions and, if specified by the shared program instructions, alter the privacy and authorization models consistent with the shared program instructions.

11. A database system according to claim 10, wherein the transaction is submitted by the second database user and the shared program instructions, when executed by the processor, change at least the first database user's access to the first subset of the data records.

12. A database system according to claim 10, wherein the transaction is submitted by the second database user and the shared program instructions, when executed by the processor, change at least the first database user's first set of authorizations that permit the first database user to manipulate the first subset of the data records.

13. A database system according to claim 11 further comprising an evidence log and program instructions stored in the memory that, when executed by the processor:
record an execution history of the shared program instructions;
record a request to submit the transaction; and/or
record any cryptographic authorizations submitted along with the transaction,
wherein the shared program instructions, when executed by the processor, alter the privacy and authorization models only if certain data is present or not present in the evidence log or the transaction.

14. A database system according to claim 4, wherein the shared program instructions, when executed by the processor, perform step 3 of claim 1 and commit the transaction only if certain data is present or not present in the evidence log or the transaction itself.

15. A database system according to claim 1, wherein the shared program instructions, when executed by the processor, commit both the transaction and evidence of its privacy and authorization validity simultaneously.

16. A method of processing a plurality of transactions using a database system comprising a database system memory configured to store a database of data records, and at least a first database server including a processor, the method comprising:
a) processing a transaction submitted by a first or second database user to the database server;
b) determining whether the transaction conforms to a privacy model and an authorization model defined by shared program instructions between the first and second database users, wherein the privacy model comprises privacy restrictions for the first and second database users, respectively, and the authorization model comprises a first set of authorizations that permit the first database user to manipulate a first subset of the data records consistent with the first user's privacy restrictions and a second set of authorizations that permit the second user to manipulate a second subset of the data records consistent with the second user's privacy restrictions; and
c) if the transaction passes step (b), committing the transaction and manipulating the first or second subset of data records consistent with the privacy and authorization models.

17. A method according to claim 16 further comprising the step of:
validating that the transaction includes cryptographic authorization from the first or second database user in accordance with the privacy model and/or authorization model.

18. A method according to claim 16, wherein the transaction includes a request to manipulate, consistent with the first set of authorizations, the first subset of data records in response to a condition, wherein step 16.b) comprises verifying occurrence of the condition and manipulating the first subset of data records consistent with the privacy and authorization models.

19. A method according to claim 18, wherein the condition includes determining whether a status of another transaction or a subset of the data records meets certain criteria.

20. A method according to claim 16, wherein the privacy model and/or authorization model specify one or more anticipated actions or results, as part of the submitted transaction.

21. A method according to claim 16, wherein the database system further comprises an evidence log, the method further comprising:
a) recording an execution history of the shared program instructions;
b) recording a request to submit the transaction, and/or
c) recording any cryptographic authorizations submitted along with the transaction.

22. A method according to claim 21, further comprising:
validating that the privacy restrictions for the first or second database users in the privacy model and the first or second set of authorizations in the authorization model conform to respective global rules for the database system; and
recording evidence of validation of the privacy restrictions and authorizations in the evidence log.

23. A method according to claim 16 further comprising:
executing a concurrency control protocol to process concurrent transactions submitted to the database system.

24. A method according to claim 16, wherein the database system memory stores program instructions, at least in part, as stored procedures, wherein the method further comprises a procedural handler of the database server performing the steps of:
determining, from the transaction submitted by the first or second database user, one or more stored procedures suitable to process the transaction;
processing, at least in part, the transaction by executing the one or more stored procedures.
